(19) United States
(12) Patent Application Publication
(10) Pub. No.: US 2025/0273789 A1
(43) Pub. Date: Aug. 28, 2025

(54) INVERTED BATTERY ENCLOSURE

(71) Applicant: Rivian IP Holdings, LLC, Irvine, CA (US)

(72) Inventors: Adam Richard BALLARD, Corona, CA (US); Piyush KHATER, Mission Viejo, CA (US); Tyler JACOBS, Hawthorne, CA (US); Mukund GANAPATHY, Milpitas, CA (US); Sriniket Sreenivas ACHAR, Sterling Heights, MI (US); Stephen John JOHANSON, New Malden (GB); Jonathan Christopher WILSON, Rancho Mission Viejo, CA (US); Atul Arun SONAWANE, Irvine, CA (US); Youngbin LIM, Irvine, CA (US); Akash THOMBRE, Tustin, CA (US)

(21) Appl. No.: 18/628,516

(22) Filed: Apr. 5, 2024

Related U.S. Application Data
(60) Provisional application No. 63/557,395, filed on Feb. 23, 2024.

(51) Int. Cl. H01M 50/242; H01M 50/244; H01M 50/249; H01M 50/262; H01M 50/271; H01M 50/289

(52) U.S. Cl. CPC H01M 50/242; H01M 50/244; H01M 50/262; H01M 50/271; H01M 50/289; H01M 50/249; H01M 2220/20

(57) ABSTRACT

Aspects of the subject technology relate to an inverted battery enclosure, such as an inverted battery enclosure for a battery pack for a vehicle. The inverted battery enclosure may include a lid, and one or more battery cells and/or battery subassemblies attached to an interior surface of the lid. A gap may be provided, within the enclosure, between the battery cells and a bottom of the enclosure. One or more impact absorption features may be provided along a sidewall of the lid.

### CROSS REFERENCE TO RELATED APPLICATIONS

This application claims the benefit of priority to U.S. Provisional Patent Application No. 63/557,395, entitled, “Inverted Battery Enclosure”, filed on Feb. 23, 2024, the disclosure of which is hereby incorporated herein in its entirety.

### INTRODUCTION

Batteries are often used as a source of power, including as a source of power for electric vehicles that include wheels that are driven by an electric motor that receives power from the battery.

Aspects of the subject technology can help to improve the efficiency, serviceability, reliability, and/or range of electric vehicles, which can help to mitigate climate change by reducing greenhouse gas emissions.

### SUMMARY

Aspects of the subject technology relate to an inverted battery assembly for a battery pack, such as a battery pack for a vehicle. For example, an inverted battery assembly may form an energy volume for the battery pack. The inverted battery assembly may include a lid, and one or more battery cells, battery modules, and/or other battery subassemblies attached to the lid. In this way, the torsional stiffness of the battery pack, and/or a vehicle in which the battery pack is installed, may be increased. Modal performance of the battery pack, and/or a vehicle in which the battery pack is installed, may also be improved. In one or more implementations, the lid of the battery pack may form a floor of a vehicle. This can reduce the amount of material used to form the vehicle, which can improve the efficiency, and/or range of electric vehicles. The lid may be provided with sidewall structures for improving side impact performance of the battery pack, and/or a vehicle in which the battery pack is installed.

In accordance with aspects of the disclosure, an apparatus is provided that includes a battery pack, the battery pack including a lid that forms a top and a plurality of sidewalls of an energy volume enclosure of the battery pack; one or more battery subassemblies enclosed within a space defined by the top and the plurality of sidewalls of the lid; and a tray attached to the lid to enclose the one or more battery subassemblies within the space defined by the top and the plurality of sidewalls of the lid. The tray may form a bottom wall of the energy volume enclosure and may be configured to attach to the lid using a plurality of fasteners disposed around a periphery of the energy volume enclosure to enclose the one or more battery subassemblies within the space defined by the top and the plurality of sidewalls of the lid. The battery pack may also include an air gap between the tray and the one or more battery subassemblies.

The one or more battery subassemblies may each include one or more battery cells, each of the one or more battery cells having a vent disposed adjacent the air gap. Each of the one or more battery subassemblies may be attached to the lid. Each of the one or more battery subassemblies may include a current collector assembly having a standoff that defines a spacing between the one or more battery subassemblies and the lid. The battery pack may also include a potting material in an interstitial space between two or more battery cells of each of the one or more battery subassemblies, and in a space between the one or more battery subassemblies and the lid. The air gap between the tray and the one or more battery subassemblies may be free of the potting material, and the potting material may attach the one or more battery subassemblies to the lid.

The tray may include a plurality of ribs; and a feature between adjacent pairs of the plurality of ribs, the feature configured to interface with a longitudinal member of the energy volume enclosure to fluidly isolate a first region within the energy volume enclosure from a second region within the energy volume enclosure. The battery pack may also include a skid plate attached to an outer surface of the tray. The tray may be attached to the longitudinal member of the energy volume enclosure by one or more fasteners, and the skid plate may include one or more ribs positioned within a space defined by one of the ribs of the tray. The apparatus may also include a plurality of impact absorption features mounted along one of the plurality of sidewalls of the lid. The apparatus may include a vehicle, and the battery pack may be implemented in the vehicle.

In accordance with other aspects of the disclosure, an enclosure for a battery pack may be provided, the enclosure including a front end; a rear end; a sidewall extending between the front end and the rear end; a first plurality of impact absorption features on an external surface of the sidewall; and a second plurality of impact absorption features on an internal surface of the sidewall. The enclosure may also include a lid; and an outer longitudinal member extending from the front end to the rear end. The second plurality of impact absorption features may include a plurality of bulkheads that are attached to the outer longitudinal member and positioned interior to the lid. The first plurality of impact absorption features may include at least one beam attached to an outer surface of the lid, the at least one beam extending in a direction that runs between the front end and the rear end. The at least one beam may include a first beam attached to the outer surface of the lid at a top of the sidewall; and a second beam attached to a flange at a bottom of the lid. The first plurality of impact absorption features may include a plurality of reinforcement members attached to, and spaced apart along, the second beam.

In accordance with other aspects of the disclosure, a method may be provided that includes lowering a battery subassembly into a lid of an energy volume enclosure of a battery pack while the lid is in an inverted position; attaching the battery subassembly to the lid; providing a potting material into an interstitial space between two or more battery cells in the battery subassembly; flipping the lid having the battery subassembly attached thereto; and enclosing the battery subassembly within the energy volume enclosure by attaching a tray of the energy volume enclosure to the lid of the energy volume enclosure. Lowering the battery subassembly into the lid may include lowering the battery subassembly into the lid while the battery subassembly is in an inverted configuration of the battery subassembly. The method may also include providing the battery pack in a vehicle. Attaching the battery subassembly to the lid may include attaching the battery subassembly to the lid with the potting material. The method may also include mechanically coupling a modular electrical component assembly to the lid, and electrically coupling the modular electrical component assembly to the battery subassembly via the lid.

### BRIEF DESCRIPTION OF THE DRAWINGS

Certain features of the subject technology are set forth in the appended claims. However, for purpose of explanation, several embodiments of the subject technology are set forth in the following figures.

FIGS. 1A and 1B illustrate schematic perspective side views of example implementations of a vehicle having a battery pack in accordance with one or more implementations.

FIG. 1C illustrates a schematic perspective view of a building having a battery pack in accordance with one or more implementations.

FIG. 2A illustrates a schematic perspective view of a battery pack in accordance with one or more implementations.

FIG. 2B illustrates schematic perspective views of various battery modules that may be included in a battery pack in accordance with one or more implementations.

FIG. 2C illustrates a cross-sectional end view of a battery cell in accordance with one or more implementations.

FIG. 2D illustrates a cross-sectional perspective view of a cylindrical battery cell in accordance with one or more implementations.

FIG. 2E illustrates a cross-sectional perspective view of a prismatic battery cell in accordance with one or more implementations.

FIG. 2F illustrates a cross-sectional perspective view of a pouch battery cell in accordance with one or more implementations.

FIG. 3 illustrates a cross-sectional side view of a battery pack in accordance with one or more implementations.

FIG. 4 illustrates a battery pack in various stages of assembly in accordance with one or more implementations.

FIG. 5 illustrates a partially exploded rear view of a battery pack in accordance with one or more implementations.

FIG. 6 illustrates an assembled rear view of a battery pack in accordance with one or more implementations.

FIG. 7 illustrates a top view of a battery subassembly in accordance with one or more implementations.

FIG. 8A illustrates a top view of an inverted lid for a battery pack with a battery subassembly installed therein in accordance with one or more implementations.

FIG. 8B illustrates a cross-sectional side view of a process for providing a battery subassembly in an inverted lid of a battery pack in accordance with one or more implementations.

FIG. 9 illustrates a cross-sectional view of a portion of a battery pack in an inverted configuration during assembly in accordance with one or more implementations.

FIG. 10 illustrates aspects of datuming for a battery pack assembly in accordance with one or more implementations.

FIG. 11 illustrates a top view of a tray for a battery pack in accordance with one or more implementations.

FIG. 12 illustrates a cross-sectional view of a portion of a battery pack in accordance with one or more implementations.

FIG. 13 illustrates a cross-sectional view of another portion of a battery pack in accordance with one or more implementations.

FIG. 14 illustrates a perspective view of a portion of a sidewall of a battery pack in accordance with one or more implementations.

FIG. 15 illustrates a cross-sectional side view of a portion of a sidewall of battery pack in accordance with one or more implementations.

FIG. 16 illustrates a perspective view of an outer longitudinal member of a battery pack in accordance with one or more implementations.

FIG. 17 illustrates a perspective view of beam of a battery pack in accordance with one or more implementations.

FIG. 18 illustrates aspects of a battery pack having impact absorption features implemented in a vehicle, in accordance with one or more implementations.

FIG. 19 illustrates a flow chart of illustrative operations that may be performed for assembling a battery pack in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Aspects of the subject technology described herein relate to an inverted battery assembly. The inverted battery assembly may include one or more impact absorption features along a sidewall of the inverted battery assembly.

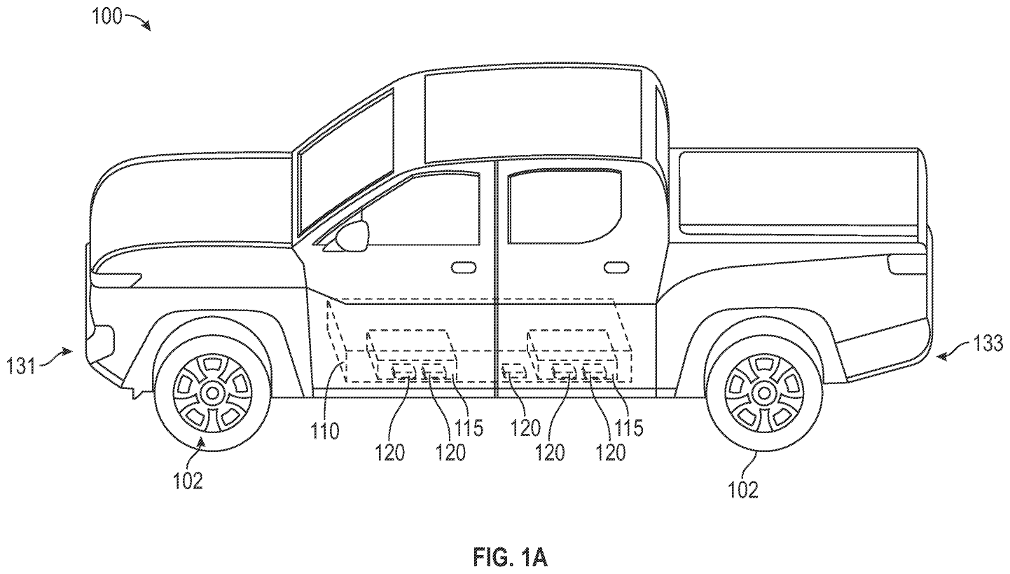

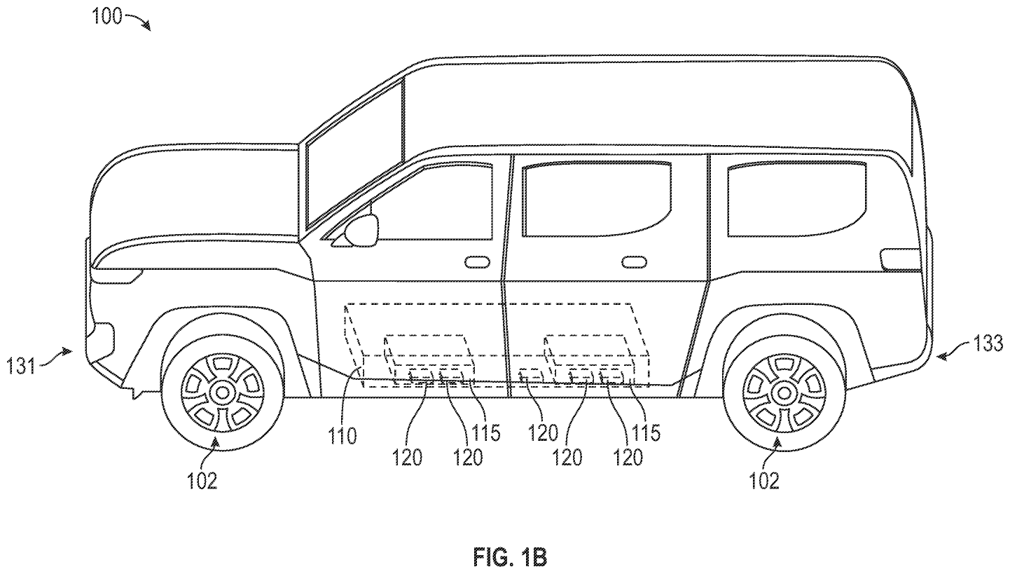

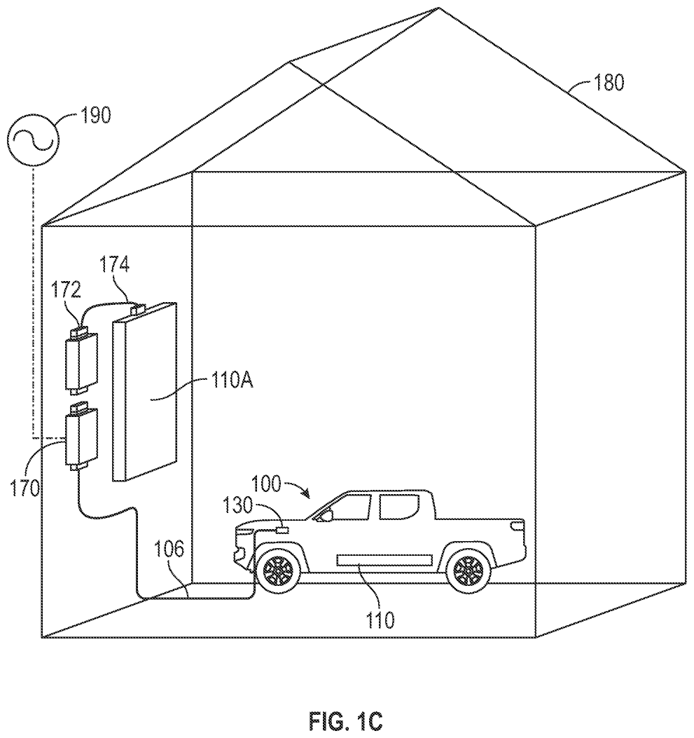

FIG. 1A is a diagram illustrating an example implementation of a moveable apparatus as described herein. In the example of FIG. 1A, a moveable apparatus is implemented as a vehicle 100. As shown, the vehicle 100 may include one or more battery packs, such as battery pack 110. The battery pack 110 may be coupled to one or more electrical systems of the vehicle 100 to provide power to the electrical systems.

In one or more implementations, the vehicle 100 may be an electric vehicle having one or more electric motors that drive the wheels 102 of the vehicle using electric power from the battery pack 110. In one or more implementations, the vehicle 100 may also, or alternatively, include one or more chemically powered engines, such as a gas-powered engine or a fuel cell powered motor. For example, electric vehicles can be fully electric or partially electric (e.g., hybrid or plug-in hybrid.

In the example of FIG. 1A, the vehicle 100 is implemented as a truck (e.g., a pickup truck) having a battery pack 110. As shown, the battery pack 110 may include one or more battery modules 115, which may include one or more battery cells 120. As shown in FIG. 1A, the battery pack 110 may also, or alternatively, include one or more battery cells 120 mounted directly in the battery pack 110 (e.g., in a cell-to-pack configuration). In one or more implementations, the battery pack 110 may be provided without any battery modules 115 and with the battery cells 120 mounted directly in the battery pack 110 (e.g., in a cell-to-pack configuration) and/or in other battery units that are installed in the battery pack 110. A vehicle battery pack can include multiple energy storage devices that can be arranged into such as battery modules or battery units. A battery unit or module can include an assembly of cells that can be combined with other elements (e.g., structural frame, thermal management devices) that can protect the assembly of cells from heat, shock and/or vibrations.

For example, the battery cell 120 can be included a battery, a battery unit, a battery module and/or a battery pack to power components of the vehicle 100. For example, a battery cell housing of the battery cell 120 can be disposed in the battery module 115, the battery pack 110, a battery array, or other battery unit installed in the vehicle 100.

As discussed in further detail hereinafter, the battery cells 120 may be provided with a battery cell housing that can be provided with any of various outer shapes. The battery cell housing may be a rigid housing in some implementations (e.g., for cylindrical or prismatic battery cells). The battery cell housing may also, or alternatively, be formed as a pouch or other flexible or malleable housing for the battery cell in some implementations. In various other implementations, the battery cell housing can be provided with any other suitable outer shape, such as a triangular outer shape, a square outer shape, a rectangular outer shape, a pentagonal outer shape, a hexagonal outer shape, or any other suitable outer shape. In some implementations, the battery pack 110 may not include modules (e.g., the battery pack may be module-free). For example, the battery pack 110 can have a module-free or cell-to-pack configuration in which the battery cells 120 are arranged directly into the battery pack 110 without assembly into a battery module 115. In one or more implementations, the vehicle 100 may include one or more busbars, electrical connectors, or other charge collecting, current collecting, and/or coupling components to provide electrical power from the battery pack 110 to various systems or components of the vehicle 100. In one or more implementations, the vehicle 100 may include control circuitry such as a power stage circuit that can be used to convert DC power from the battery pack 110 into AC power for one or more components and/or systems of the vehicle (e.g., including one or more power outlets of the vehicle and/or the motor(s) that drive the wheels 102 of the vehicle). The power stage circuit can be provided as part of the battery pack 110 or separately from the battery pack 110 within the vehicle 100. The vehicle 100 may have a front end 131 and a rear end 133.

The example of FIG. 1A in which the vehicle 100 is implemented as a pickup truck having a truck bed at the rear portion thereof is merely illustrative. For example, FIG. 1B illustrates another implementation in which the vehicle 100 including the battery pack 110 is implemented as a sport utility vehicle (SUV), such as an electric sport utility vehicle. In the example of FIG. 1B, the vehicle 100 including the battery pack 110 may include a cargo storage area that is enclosed within the vehicle 100 (e.g., behind a row of seats within a cabin of the vehicle). In other implementations, the vehicle 100 may be implemented as another type of electric truck, an electric delivery van, an electric automobile, an electric car, an electric motorcycle, an electric scooter, an electric bicycle, an electric passenger vehicle, an electric passenger or commercial truck, a hybrid vehicle, an aircraft, a watercraft, and/or any other movable apparatus having a battery pack 110 (e.g., a battery pack or other battery unit that powers the propulsion or drive components of the moveable apparatus).

In one or more implementations, a battery pack such as the battery pack 110, a battery module 115, a battery cell 120, and/or any other battery unit as described herein may also, or alternatively, be implemented as an electrical power supply and/or energy storage system in a building, such as a residential home or commercial building. For example, FIG. 1C illustrates an example in which a battery pack 110 is implemented in a building 180. For example, the building 180 may be a residential building, a commercial building, or any other building. As shown, in one or more implementations, a battery pack 110 may be mounted to a wall of the building 180.

As shown, the battery 110A that is installed in the building 180 may be couplable to the battery pack 110 in the vehicle 100, such as via: a cable/connector 106 that can be connected to the charging port 130 of the vehicle 100, electric vehicle supply equipment 170 (EVSE), a power stage circuit 172, and/or a cable/connector 174. For example, the cable/connector 106 may be coupled to the EVSE 170, which may be coupled to the battery 110A via the power stage circuit 172, and/or may be coupled to an external power source 190. In this way, either the external power source 190 or the battery 110A that is installed in the building 180 may be used as an external power source to charge the battery pack 110 in the vehicle 100 in some use cases. In some examples, the battery 110A that is installed in the building 180 may also, or alternatively, be coupled (e.g., via a cable/connector 174, the power stage circuit 172, and the EVSE 170) to the external power source 190. For example, the external power source 190 may be a solar power source, a wind power source, and/or an electrical grid of a city, town, or other geographic region (e.g., electrical grid that is powered by a remote power plant). During, for example, times when the battery pack 110 in the vehicle 100 is not coupled to the battery 110A that is installed in the building 180, the battery 110A that is installed in the building 180 can be coupled (e.g., using the power stage circuit 172 for the building 180) to the external power source 190 to charge up and store electrical energy. In some use cases, this stored electrical energy in the battery 110A that is installed in the building 180 can later be used to charge the battery pack 110 in the vehicle 100 (e.g., during times when solar power or wind power is not available, in the case of a regional or local power outage for the building 180, and/or during a period of high rates for access to the electrical grid).

In one or more implementations, the power stage circuit 172 may electrically couple the battery 110A that is installed in the building 180 to an electrical system of the building 180. For example, the power stage circuit 172 may convert DC power from the battery 110A into AC power for one or more loads in the building 180. For example, the battery 110A that is installed in the building 180 may be used to power one or more lights, lamps, appliances, fans, heaters, air conditioners, and/or any other electrical components or electrical loads in the building 180 (e.g., via one or more electrical outlets that are coupled to the battery 110A that is installed in the building 180). For example, the power stage circuit 172 may include control circuitry that is operable to switchably couple the battery 110A between the external power source 190 and one or more electrical outlets and/or other electrical loads in the electrical system of the building 180. In one or more implementations, the vehicle 100 may include a power stage circuit (not shown in FIG. 1C) that can be used to convert power received from the electric vehicle supply equipment 170 to DC power that is used to power/charge the battery pack 110 of the vehicle 100, and/or to convert DC power from the battery pack 110 into AC power for one or more electrical systems, components, and/or loads of the vehicle 100.

In one or more use cases, the battery 110A that is installed in the building 180 may be used as a source of electrical power for the building 180, such as during times when solar power or wind power is not available, in the case of a regional or local power outage for the building 180, and/or during a period of high rates for access to the electrical grid (as examples). In one or more other use cases, the battery pack 110 that is installed in the vehicle may be used to charge the battery 110A that is installed in the building 180 and/or to power the electrical system of the building 180 (e.g., in a use case in which the battery 110A that is installed in the building 180 is low on or out of stored energy and in which solar power or wind power is not available, a regional or local power outage occurs for the building 180, and/or a period of high rates for access to the electrical grid occurs (as examples)).

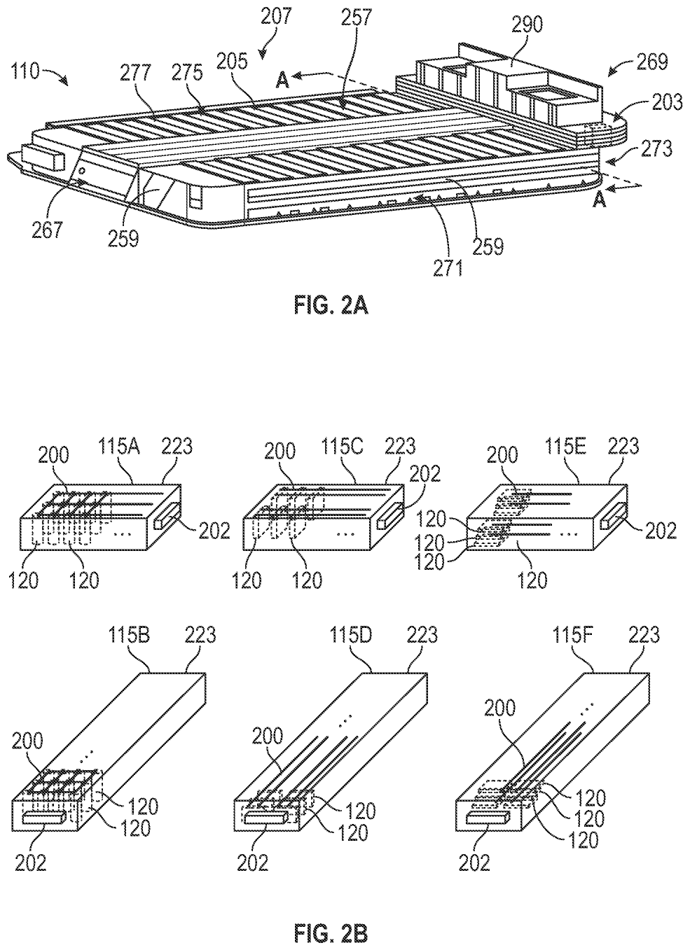

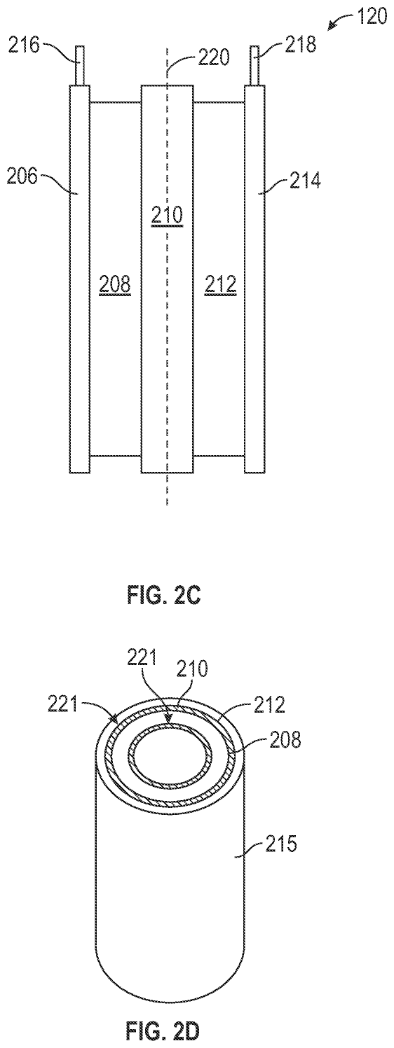

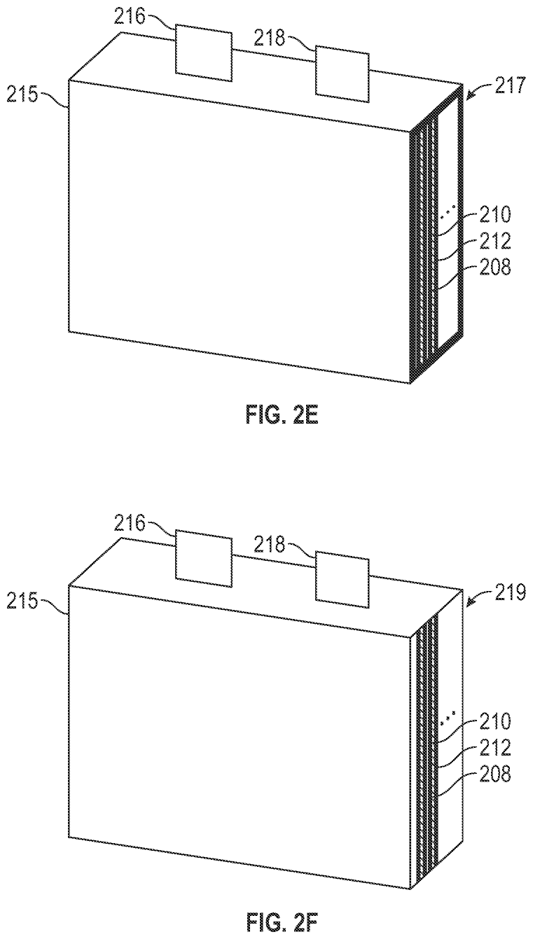

FIG. 2A depicts an example battery pack 110, in accordance with one or more implementations. As shown, the battery pack 110 may include an energy volume enclosure 205 (e.g., a battery pack housing, sometimes referred to herein as an enclosure). For example, the energy volume enclosure 205 may house or enclose an energy volume 207 for the battery pack 110, the energy volume 207 including one or more battery modules 115 and/or one or more battery cells 120, and/or other battery pack components. In one or more implementations, the energy volume enclosure 205 may include or form a shielding structure on an outer surface thereof (e.g., a bottom thereof and/or underneath one or more battery module 115, battery units, batteries, and/or battery cells 120) to protect the battery module 115, battery units, batteries, and/or battery cells 120 from external conditions (e.g., if the battery pack 110 is installed in a vehicle 100 and the vehicle 100 is driven over rough terrain, such as off-road terrain, trenches, rocks, rivers, streams, etc.).

Battery pack 110 may include, within the energy volume 207 and the energy volume enclosure 205, multiple battery cells 120 (e.g., directly installed within the battery pack 110, or within batteries, battery units, battery subassemblies, and/or battery modules 115 as described herein) and/or battery modules 115, and one or more conductive coupling elements for coupling a voltage generated by the battery cells 120 to a power-consuming component, such as the vehicle 100 and/or an electrical system of a building 180. For example, the conductive coupling elements may include internal connectors and/or contactors that couple together multiple battery cells 120, battery units, batteries, battery subassemblies, and/or multiple battery modules 115 within the energy volume enclosure 205 to generate a desired output voltage for the battery pack 110.

As shown, the battery pack 110 may also include a modular electrical component assembly 290 (e.g., including a modular electronic component enclosure or a modular electrical component enclosure) mounted to the energy volume enclosure 205. In one or more implementations, the modular electrical component assembly 290 may include one or more of the conductive coupling elements for routing power from the battery cells 120 and/or battery modules 115 within the energy volume enclosure 205 (e.g., within the energy volume 207) to one or more external connection ports, such as an electrical contact 203 (e.g., a high voltage terminal, port, or connector). For example, an electrical cable or harness may be connected between the electrical contact 203 and an electrical system of the vehicle 100 or the building 180, to provide electrical power to the vehicle 100 or the building 180. The energy volume enclosure 205 may have a front end 267 and a rear end 269. In one or more implementations, when the battery pack 110 is installed in the vehicle 100, the battery pack 110 may be arranged with the front end 267 closer to the front end 131 of the vehicle and the rear end 269 closer to the rear end 133 of the vehicle. As shown, the modular electrical component assembly 290 may be mounted to the energy volume enclosure 205 (e.g., to a lid 277 of the energy volume enclosure 205) at or near the rear end 269 in one or more implementations.

In one or more implementations, the battery pack 110 may include one or more additional features, such as thermal control structures (e.g., cooling lines and/or plates and/or heating lines and/or plates). For example, thermal control structures may couple thermal control structures and/or fluids to the battery modules 115, battery units, batteries, and/or battery cells 120 within the energy volume enclosure 205, such as by distributing fluid through the battery pack 110.

For example, the thermal control structures may form a part of a thermal/temperature control or heat exchange system that includes one or more thermal components such as plates or bladders that are disposed in thermal contact with one or more battery modules 115 and/or battery cells 120 disposed within the energy volume enclosure 205. For example, a thermal component may be positioned in contact with one or more battery modules 115, battery units, batteries, and/or battery cells 120 within the energy volume enclosure 205. In one or more implementations, the battery pack 110 may include one or multiple thermal control structures and/or other thermal components for each of several top and bottom battery module pairs. As shown, the battery pack 110 may include an electrical contact 203 (e.g., a high voltage connector or port) by which an external load (e.g., the vehicle 100 or an electrical system of the building 180) may be electrically coupled to the battery modules and/or battery cells in the battery pack 110.

As shown, the energy volume enclosure 205 of the battery pack 110 may include a lid 277. For example, the lid 277 may cover and extend over one or more battery modules 115, battery cells 120, and/or other battery subassemblies within the energy volume enclosure 205. In the example of FIG. 2A, the lid 277 may be a deep-drawn structure that forms a top 257, and one or more sidewalls 259 (e.g., four sidewalls), of the energy volume enclosure 205. As discussed in further detail hereinafter, the energy volume enclosure 205 may also include a tray or other housing structure (e.g., at the bottom of the energy volume enclosure) that interfaces with the lid 277 to enclose one or more battery modules 115, battery cells 120, and/or other battery subassemblies within the energy volume enclosure 205 (e.g., within a space defined by the top 257 and the sidewalls 259 of the lid 277). For example, the energy volume enclosure 205 may include a tray panel that is removable to expose an opening in the bottom of the lid 277.

In the example of FIG. 2A, the lid 277 is provided with ribbing 275 (e.g., for additional strength). In the example of FIG. 2A, the battery pack 110 includes one or more mounting features 273 (e.g., for mounting the battery pack 110 to one or more body structures of a vehicle, such as the vehicle 100). As shown in FIG. 2A, and as discussed in further detail hereinafter, the energy volume enclosure 205 may include one or more sidewall structures 271. The sidewall structures 271 may be attached to, and/or extend long, a sidewall 259 of the lid 277, and may provide impact absorption and/or redistribution functions to distribute energy from a side impact to the battery pack 110 (e.g., from a side impact to a vehicle 100) away from and/or around the one or more battery modules 115, battery cells 120, and/or other battery subassemblies within the energy volume enclosure 205.

FIG. 2B depicts various examples of battery modules 115 that may be disposed in the battery pack 110 (e.g., within the energy volume enclosure 205 of FIG. 2A). In the example of FIG. 2B, a battery module 115A is shown that includes a battery module housing 223 having a rectangular cuboid shape with a length that is substantially similar to its width. In this example, the battery module 115A includes multiple battery cells 120 implemented as cylindrical battery cells. In this example, the battery module 115A includes rows and columns of cylindrical battery cells that are coupled together by an interconnect structure 200 (e.g., a current connector assembly or CCA). For example, the interconnect structure 200 may couple together the positive terminals of the battery cells 120, and/or couple together the negative battery terminals of the battery cells 120. As shown, the battery module 115A may include a charge collector or bus bar 202. For example, the bus bar 202 may be electrically coupled to the interconnect structure 200 to collect the charge generated by the battery cells 120 to provide a high voltage output from the battery module 115A.

FIG. 2B also shows a battery module 115B having an elongate shape, in which the length of the battery module housing 223 (e.g., extending along a direction from a front end of the battery pack 110 to a rear end of the battery pack 110 when the battery module 115B is installed in the battery pack 110) is substantially greater than a width (e.g., in a transverse direction to the direction from the front end of the battery pack 110 to the rear end of the battery pack 110 when the battery module 115B is installed in the battery pack 110) of the battery module housing 223. For example, one or more battery modules 115B may span the entire front-to-back length of a battery pack within the energy volume enclosure 205. As shown, the battery module 115B may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115B.

In the implementations of battery module 115A and battery module 115B, the battery cells 120 are implemented as cylindrical battery cells. However, in other implementations, a battery module may include battery cells having other form factors, such as a battery cells having a right prismatic outer shape (e.g., a prismatic cell), or a pouch cell implementation of a battery cell. As an example, FIG. 2B also shows a battery module 115C having a battery module housing 223 having a rectangular cuboid shape with a length that is substantially similar to its width and including multiple battery cells 120 implemented as prismatic battery cells. In this example, the battery module 115C includes rows and columns of prismatic battery cells that are coupled together by an interconnect structure 200 (e.g., a current collector assembly or CCA). For example, the interconnect structure 200 may couple together the positive terminals of the battery cells 120 and/or couple together the negative battery terminals of the battery cells 120. As shown, the battery module 115C may include a charge collector or bus bar 202. For example, the bus bar 202 may be electrically coupled to the interconnect structure 200 to collect the charge generated by the battery cells 120 to provide a high voltage output from the battery module 115C.

FIG. 2B also shows a battery module 115D including prismatic battery cells and having an elongate shape, in which the length of the battery module housing 223 (e.g., extending along a direction from a front end of the battery pack 110 to a rear end of the battery pack 110 when the battery module 115D is installed in the battery pack 110) is substantially greater than a width (e.g., in a transverse direction to the direction from the front end of the battery pack 110 to the rear end of the battery pack 110 when the battery module 115D is installed in the battery pack 110) of the battery module housing 223. For example, one or more battery modules 115D having prismatic battery cells may span the entire front-to-back length of a battery pack within the energy volume enclosure 205. As shown, the battery module 115D may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115D.

As another example, FIG. 2B also shows a battery module 115E having a battery module housing 223 having a rectangular cuboid shape with a length that is substantially similar to its width and including multiple battery cells 120 implemented as pouch battery cells. In this example, the battery module 115C includes rows and columns of pouch battery cells that are coupled together by an interconnect structure 200 (e.g., a current collector assembly or CCA). For example, the interconnect structure 200 may couple together the positive terminals of the battery cells 120 and couple together the negative battery terminals of the battery cells 120. As shown, the battery module 115E may include a charge collector or bus bar 202. For example, the bus bar 202 may be electrically coupled to the interconnect structure 200 to collect the charge generated by the battery cells 120 to provide a high voltage output from the battery module 115E.

FIG. 2B also shows a battery module 115F including pouch battery cells and having an elongate shape in which the length of the battery module housing 223 (e.g., extending along a direction from a front end of the battery pack 110 to a rear end of the battery pack 110 when the battery module 115E is installed in the battery pack 110) is substantially greater than a width (e.g., in a transverse direction to the direction from the front end of the battery pack 110 to the rear end of the battery pack 110 when the battery module 115E is installed in the battery pack 110) of the battery module housing 223. For example, one or more battery modules 115E having pouch battery cells may span the entire front-to-back length of a battery pack within the energy volume enclosure 205. As shown, the battery module 115E may also include a bus bar 202 electrically coupled to the interconnect structure 200. For example, the bus bar 202 may be electrically coupled to the interconnect structure 200 to collect the charge generated by the battery cells 120 to provide a high voltage output from the battery module 115E.

In various implementations, a battery pack 110 may be provided with one or more of any of the battery modules 115A, 115B, 115C, 115D, 115E, and 115F. In one or more other implementations, a battery pack 110 may be provided without battery modules 115 (e.g., in a cell-to-pack implementation). In one or more implementations, a battery pack 110 may be provided with three elongated battery modules (e.g., three of battery modules 115B, 115D, and/or 115F).

In one or more implementations, multiple battery modules 115 in any of the implementations of FIG. 2B may be coupled (e.g., in series) to a current collector of the battery pack 110. In one or more implementations, the current collector may be coupled, via a high voltage harness, to one or more external connectors (e.g., electrical contact 203) on the battery pack 110. In one or more implementations, the battery pack 110 may be provided without any battery modules 115. For example, the battery pack 110 may have a cell-to-pack configuration in which battery cells 120 are arranged directly into the battery pack 110 without assembly into a battery module 115 (e.g., without including a separate battery module housing 223). For example, the battery pack 110 (e.g., the energy volume enclosure 205) may include or define a plurality of structures for positioning of the battery cells 120 directly within the energy volume enclosure 205.

FIG. 2C illustrates a cross-sectional end view of a portion of a battery cell 120. As shown in FIG. 2C, a battery cell 120 may include an anode 208, an electrolyte 210, and a cathode 212. As shown, the anode 208 may include or be electrically coupled to a first current collector 206 (e.g., a metal layer such as a layer of copper foil or other metal foil). As shown, the cathode 212 may include or be electrically coupled to a second current collector 214 (e.g., a metal layer such as a layer of aluminum foil or other metal foil). As shown, the battery cell 120 may include a first terminal 216 (e.g., a negative terminal) coupled to the anode 208 (e.g., via the first current collector 206) and a second terminal 218 (e.g., a positive terminal) coupled to the cathode (e.g., via the second current collector 214). In various implementations, the electrolyte 210 may be a liquid electrolyte layer or a solid electrolyte layer. In one or more implementations (e.g., implementations in which the electrolyte 210 is a liquid electrolyte layer), the battery cell 120 may include a separator layer 220 that separates the anode 208 from the cathode 212. In one or more implementations in which the electrolyte 210 is a solid electrolyte layer, the solid electrolyte layer may act as both separator layer and an electrolyte layer.

In one or more implementations, the battery cell 120 may be implemented as a lithium ion battery cell in which the anode 208 is formed from a carbonaceous material (e.g., graphite or silicon-carbon). In these implementations, lithium ions can move from the anode 208, through the electrolyte 210, to the cathode 212 during discharge of the battery cell 120 (e.g., and through the electrolyte 210 from the cathode 212 to the anode 208 during charging of the battery cell 120). For example, the anode 208 may be formed from a graphite material that is coated on a copper foil corresponding to the first current collector 206. In these lithium ion implementations, the cathode 212 may be formed from one or more metal oxides (e.g., a lithium cobalt oxide, a lithium manganese oxide, a lithium nickel manganese cobalt oxide (NMC), or the like) and/or a lithium iron phosphate. As shown, the battery cell 120 may include a separator layer 220 that separates the anode 208 from the cathode 212. In an implementation in which the battery cell 120 is implemented as a lithium-ion battery cell, the electrolyte 210 may include a lithium salt in an organic solvent. The separator layer 220 may be formed from one or more insulating materials (e.g., a polymer such as polyethylene, polypropylene, polyolefin, and/or polyamide, or other insulating materials such as rubber, glass, cellulose or the like). The separator layer 220 may prevent contact between the anode 208 and the cathode 212, and may be permeable to the electrolyte 210 and/or ions within the electrolyte 210. In one or more implementations, the battery cell 120 may be implemented as a lithium polymer battery cell having a dry solid polymer electrolyte and/or a gel polymer electrolyte.

Although some examples are described herein in which the battery cells 120 are implemented as lithium-ion battery cells, some or all of the battery cells 120 in a battery module 115, battery pack 110, or other battery or battery unit may be implemented using other battery cell technologies, such as nickel-metal hydride battery cells, sodium ion battery cells, lead-acid battery cells, and/or ultracapacitor cells. For example, in a nickel-metal hydride battery cell, the anode 208 may be formed from a hydrogen-absorbing alloy and the cathode 212 may be formed from a nickel oxide-hydroxide. In the example of a nickel-metal hydride battery cell, the electrolyte 210 may be formed from an aqueous potassium hydroxide in one or more examples.

The battery cell 120 may be implemented as a lithium sulfur battery cell in one or more other implementations. For example, in a lithium sulfur battery cell, the anode 208 may be formed at least in part from lithium, the cathode 212 may be formed from at least in part form sulfur, and the electrolyte 210 may be formed from a cyclic ether, a short-chain ether, a glycol ether, an ionic liquid, a super-saturated salt-solvent mixture, a polymer-gelled organic media, a solid polymer, a solid inorganic glass, and/or other suitable electrolyte materials.

In various implementations, the anode 208, the electrolyte 210, and the cathode 212 of FIG. 2C can be packaged into a battery cell housing having any of various shapes, and/or sizes, and/or formed from any of various suitable materials. For example, battery cells 120 can have a cylindrical, rectangular, square, cubic, flat, pouch, elongated, or prismatic outer shape. As depicted in FIG. 2D, for example, a battery cell such as the battery cell 120 may be implemented as a cylindrical cell. In the example of FIG. 2D, the battery cell 120 includes a cell housing 215 having a cylindrical outer shape. For example, the anode 208, the electrolyte 210, and the cathode 212 may be rolled into one or more substantially cylindrical windings 221. As shown, one or more windings 221 of the anode 208, the electrolyte 210, and the cathode 212 (e.g., and/or one or more separator layers such as separator layer 220) may be disposed within the cell housing 215. For example, a separator layer may be disposed between adjacent ones of the windings 221. However, the cylindrical cell implementation of FIG. 2D is merely illustrative, and other implementations of the battery cells 120 are contemplated.

For example, FIG. 2E illustrates an example in which the battery cell 120 is implemented as a prismatic cell. As shown in FIG. 2E, the battery cell 120 may have a cell housing 215 having a right prismatic outer shape. As shown, one or more layers of the anode 208, the cathode 212, and the electrolyte 210 disposed therebetween may be disposed (e.g., with separator materials between the layers) within the cell housing 215 having the right prismatic shape. As examples, multiple layer of the anode 208, electrolyte 210, and cathode 212 can be stacked (e.g., with separator materials between each layer), or a single layer of the anode 208, electrolyte 210, and cathode 212 can be formed into a flattened spiral shape and provided in the cell housing 215 having the right prismatic shape. In the implementation of FIG. 2E, the cell housing 215 has a relatively thick cross-sectional width 217 and is formed from a rigid material. For example, the cell housing 215 in the implementation of FIG. 2E may be formed from a welded, stamped, deep drawn, and/or impact extruded metal sheet, such as a welded, stamped, deep drawn, and/or impact extruded aluminum sheet. For example, the cross-sectional width 217 of the cell housing 215 of FIG. 2E may be as much as, or more than 1 millimeter (mm) to provide a rigid housing for the prismatic battery cell. In one or more implementations, the first terminal 216 and the second terminal 218 in the prismatic cell implementation of FIG. 2E may be formed from a feedthrough conductor that is insulated from the cell housing 215 (e.g., a glass to metal feedthrough) as the conductor passes through to cell housing 215 to expose the first terminal 216 and the second terminal 218 outside the cell housing 215 (e.g., for contact with an interconnect structure 200 of FIG. 2B). However, this implementation of FIG. 2E is also illustrative and yet other implementations of the battery cell 120 are contemplated.

For example, FIG. 2F illustrates an example in which the battery cell 120 is implemented as a pouch cell. As shown in FIG. 2F, one or more layers of the anode 208, the cathode 212, and the electrolyte 210 disposed therebetween may be disposed (e.g., with separator materials between the layers) within the cell housing 215 that forms a flexible or malleable pouch housing. In the implementation of FIG. 2F, the cell housing 215 has a relatively thin cross-sectional width 219. For example, the cell housing 215 in the implementation of FIG. 2F may be formed from a flexible or malleable material (e.g., a foil, such as a metal foil, or film, such as an aluminum-coated plastic film). For example, the cross-sectional width 219 of the cell housing 215 of FIG. 2F may be as low as, or less than 0.1 mm, 0.05 mm, 0.02 mm, or 0.01 mm to provide flexible or malleable housing for the pouch battery cell. In one or more implementations, the first terminal 216 and the second terminal 218 in the pouch cell implementation of FIG. 2F may be formed from conductive tabs (e.g., foil tabs) that are coupled (e.g., welded) to the anode 208 and the cathode 212 respectively, and sealed to the pouch that forms the cell housing 215 in these implementations. In the examples of FIGS. 2C, 2E, and 2F, the first terminal 216 and the second terminal 218 are formed on the same side (e.g., a top side) of the battery cell 120. However, this is merely illustrative and, in other implementations, the first terminal 216 and the second terminal 218 may formed on two different sides (e.g., opposing sides, such as a top side and a bottom side) of the battery cell 120. The first terminal 216 and the second terminal 218 may be formed on a same side or difference sides of the cylindrical cell of FIG. 2D in various implementations.

In one or more implementations, a battery module 115, a battery pack 110, a battery unit, or any other battery may include some battery cells 120 that are implemented as solid-state battery cells and other battery cells 120 that are implemented with liquid electrolytes for lithium-ion or other battery cells having liquid electrolytes. One or more of the battery cells 120 may be included a battery module 115 or a battery pack 110, such as to provide an electrical power supply for components of the vehicle 100, the building 180, or any other electrically powered component or device. The cell housing 215 of the battery cell 120 can be disposed in the battery module 115, the battery pack 110, or installed in any of the vehicle 100, the building 180, or any other electrically powered component or device.

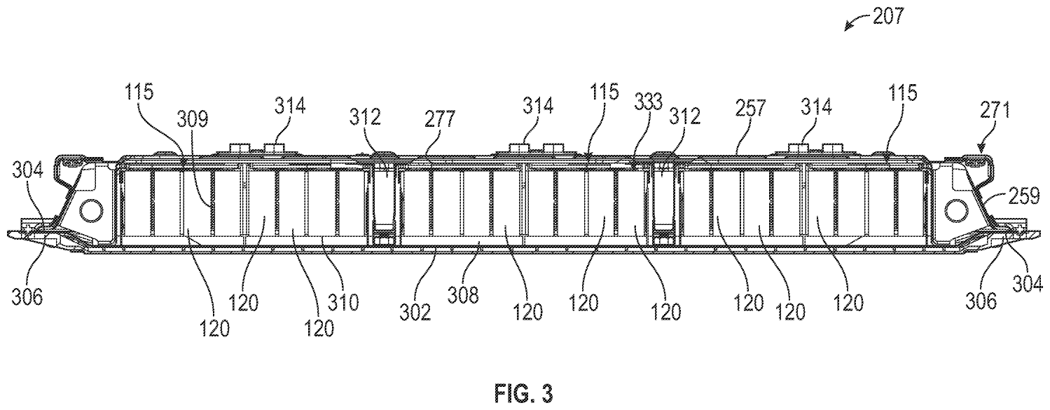

FIG. 3 illustrates a cross-sectional side view of the battery pack 110, the cross section taken along the line A-A of FIG. 2A, in accordance with one or more implementations of the subject technology. As shown in FIG. 3, the battery pack 110 may include an energy volume enclosure 205 having a lid 277. As shown, a space 333 may be defined by the top 257 and the sidewalls 259 of the lid 277, and one or more battery subassemblies, such as one or more battery modules 115, may be disposed within the space 333. In one or more implementations, the one or more battery subassemblies (e.g., battery modules 115) and/or battery cells 120 may be attached to the lid 277 (e.g., to an interior surface of the top 257 of the lid 277) and enclosed within the energy volume enclosure 205 (e.g., within the space 333). For example, the energy volume enclosure 205 may also include a tray 302 attached to the lid 277. For example, the tray 302 may form a bottom wall or bottom plate of the energy volume enclosure 205, and may be configured to attach to the lid 277 to enclose the one or more battery subassemblies and/or battery cells 120 within the space 333 defined by the top 257 and the sidewalls 259 of the lid 277.

As shown in FIG. 3, the battery pack 110 may include a gap 308 (e.g., an air gap) between the tray 302 and the one or more battery subassemblies. In one or more implementations, the one or more battery subassemblies may each include one or more battery cells 120, each of the one or more battery cells having a vent 310 disposed adjacent to and/or within the gap 308. For example, one or more battery cells 120 in the one or more battery subassemblies may include a vent 310 on a bottom side (e.g., a side facing the tray 302) of the battery cell. Providing the gap 308 between the tray 302 and the one or more battery subassemblies may help to ensure that the vents 310 of the battery cells 120 are free of blockages or obstruction (e.g., by potting material that may be present elsewhere in the battery pack 110). In one or more implementations, the battery cells 120 may include one or more terminals (e.g., terminals 216 and 218) at a top end of the cell (e.g., adjacent the lid 277). The terminals of the battery cells may be electrically coupled (e.g., by one or more current collector assemblies (CCAs), and/or busbars) to one or more high voltage terminals (e.g., terminals 314) at the top of the battery pack 110.

As described in further detail hereinafter, the battery pack 110 may also include a potting material 309 in an interstitial space between two or more battery cells 120 of each of the one or more battery subassemblies, and in a space between the one or more battery subassemblies and the lid 277. The gap 308 between the tray 302 and the one or more battery subassemblies may be free of the potting material 309.

As shown in FIG. 3, the lid 277 may include a flange 304 (e.g., along the bottom edge of a sidewall formed by the lid 277). The tray 302 may include a flange 306 that is mounted to the flange 304. As shown, the sidewall structures 271 may be located on or above the flange 304. Terminals 314 (e.g., high voltage terminals) may be provided for connecting electrical circuitry in the modular electrical component assembly 290 to the voltage generated by the battery cells 120 in the energy volume enclosure 205 (e.g., by electrically coupling the modular electrical component assembly 290 to one or more battery subassemblies within the energy volume 207 via the lid 277, when the modular electrical component assembly 290 is mechanically coupled to the lid 277).

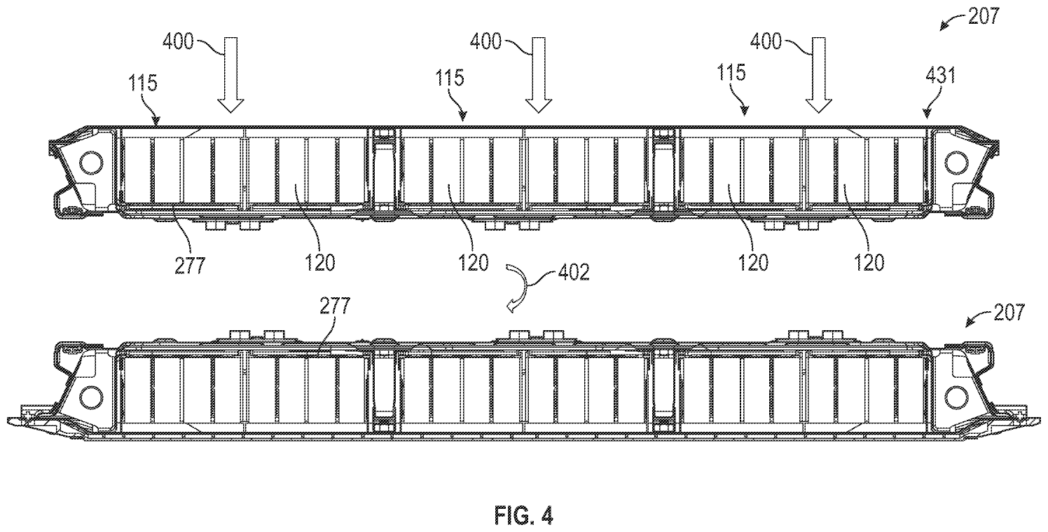

FIG. 4 illustrates the battery pack 110 at two stages of assembly of the battery pack 110. In this example, battery subassemblies (e.g., battery modules 115 and/or other groups of battery cells 120) may be lowered into the lid 277 (e.g., as indicated by arrows 400) while the lid 277 is in an inverted (e.g., “holding water”) position. For example, the lid 277 may be flipped such that the top of the lid 277 is the lowermost part of the lid 277 and an bottom opening in the lid 277 faces upward to allow the battery subassemblies to be lowered into the lid. As illustrated by arrow 402, once the battery subassemblies and/or the battery cells 120 have been attached to the lid 277 (e.g., using one or more fasteners, using an adhesive, and/or by providing the potting material 309 into the lid 277 while the lid is in the inverted position and the battery subassemblies are held in contact with the lid 277 by gravity, and allowing the potting material to cure), the lid 277 with the battery subassemblies attached thereto may be flipped so that the top of the lid is at the top, and the opening of the lid is at the bottom.

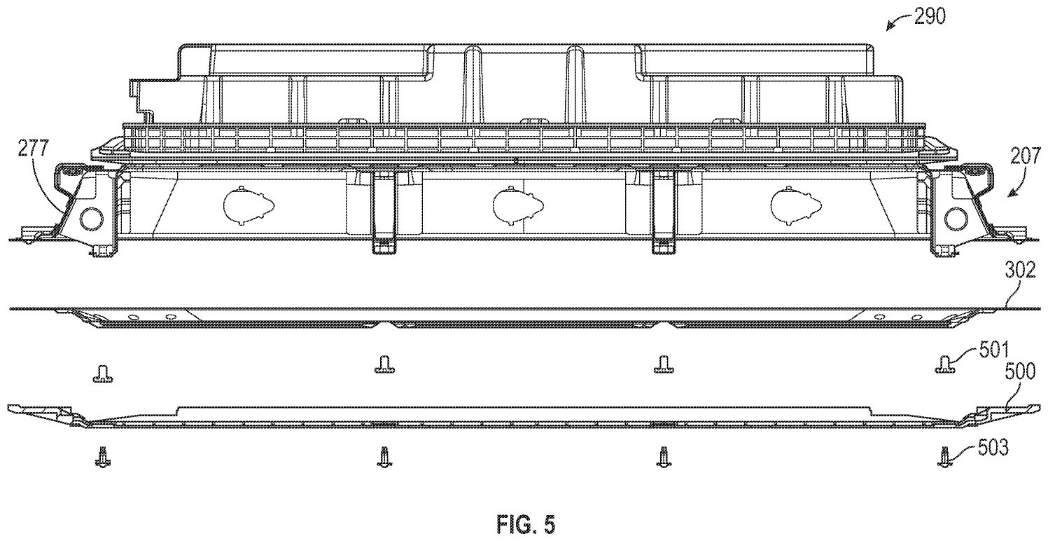

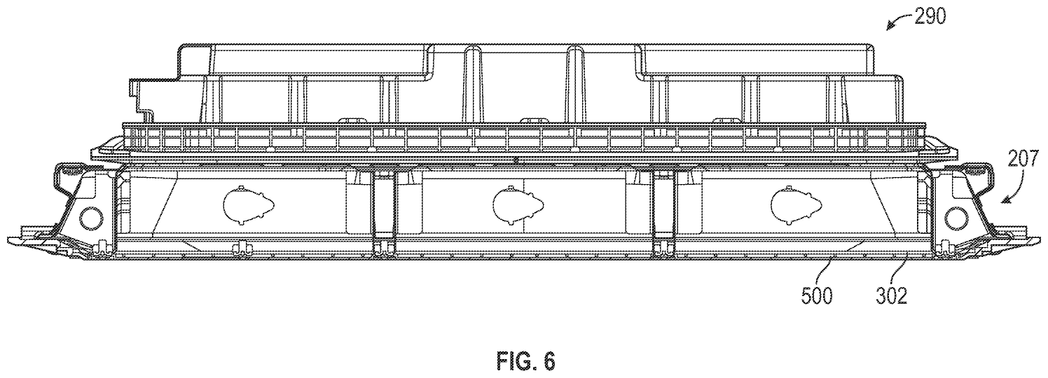

As illustrated by the rear view of the battery pack 110 shown in FIG. 5, the tray 302 may then be attached (e.g., by one or more fasteners 501, such as bolts) to the lid 277. For example, multiple bolts around the periphery of the energy volume enclosure 205 may be provided for attaching the tray 302 to the lid 277. In one or more implementations, a skid plate 500 may be attached to the battery pack 110 (e.g., to the tray 302, such as by one or more fasteners 503, such as bolts). FIG. 5 also shows how the modular electrical component assembly 290 may be mounted to the top of the lid 277 when the lid 277 is an un-inverted (e.g., upright) position. FIG. 6 illustrates a rear view of the battery pack 110 with the tray 302 and the skid plate 500 attached to the lid 277 (e.g., to the bottom of the lid) and the modular electrical component assembly 290 mounted to the top of the lid 277. In one or more implementations, the tray 302 and/or the skid plate 500 may be fastened to the lid 277 while the lid is in the inverted position (e.g., prior to flipping the lid with the battery subassemblies attached thereto), to allow the fasteners 501 and/or 503 to be fastened while the fasteners are pointing down, to aid in manufacturing ease. In the final orientation shown in FIG. 5 (e.g., the orientation in which the battery pack 110 may be attached to a vehicle 100), serviceability of the battery pack 110 may be improved by providing a bottom stack of parts (e.g., the tray 302 and/or the skid plate 500) that can be removed and replaced without having to do work on high voltage components. In one or more implementations, the tray 302 and/or the skid plate 500 may be formed from materials having higher strength and/or quality than the material of the lid 277, as the lid to which the battery subassemblies are attached may be isolated from exposure to road abuse.

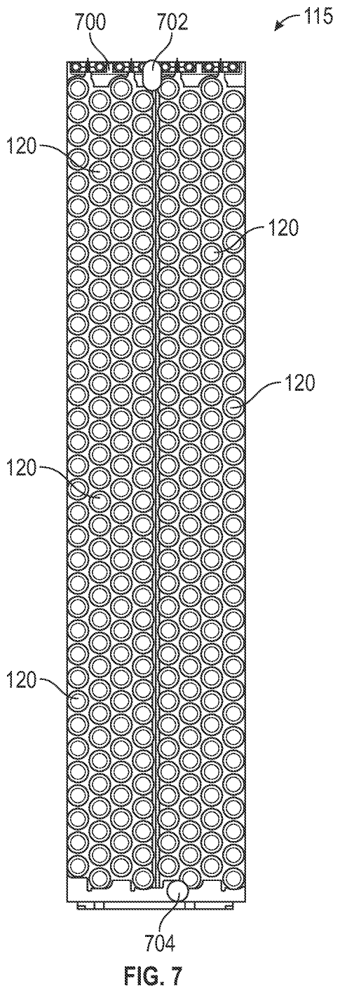

FIG. 7 illustrates a top view of an example battery subassembly, implemented as a battery module 115 (e.g., battery module 115B) including multiple battery cells 120. In one or more implementations, the battery subassembly may include a carrier 700 in which the battery cells 120 can be placed prior to insertion of the battery subassembly into the lid 277. In one or more implementations, the carrier 700 may be formed from an insulating material, such as plastic. As shown in FIG. 7, the carrier 700 may be provided with one or more datuming features, such as a two-way datum 702 at one end of the carrier 700 and a four-way datum 704 at an opposing end of the carrier 700. In one or more implementations, the two-way datum 702 and/or the four-way datum 704 may also, or alternatively, be provided in a current collector assembly (CCA) of the battery subassembly. In the example of FIG. 7, the battery subassembly (e.g., battery module 115) is shown in a top-down view in a module pick position (e.g., positioned for lifting and inserting into the inverted lid 277), such as after the flipping the battery module 115 after insertion of the battery cells 120 in the carrier 700. In one or more implementations, a module lift assist may pin to the two-way datum 702 and/or the four-way datum 704 (e.g., on the carrier 700 and/or the CCA).

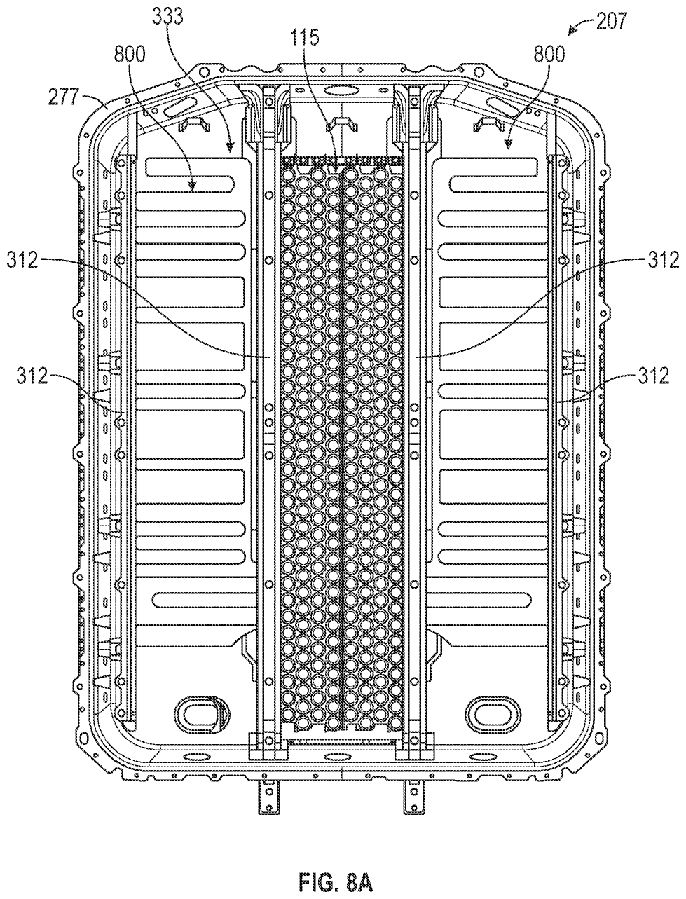

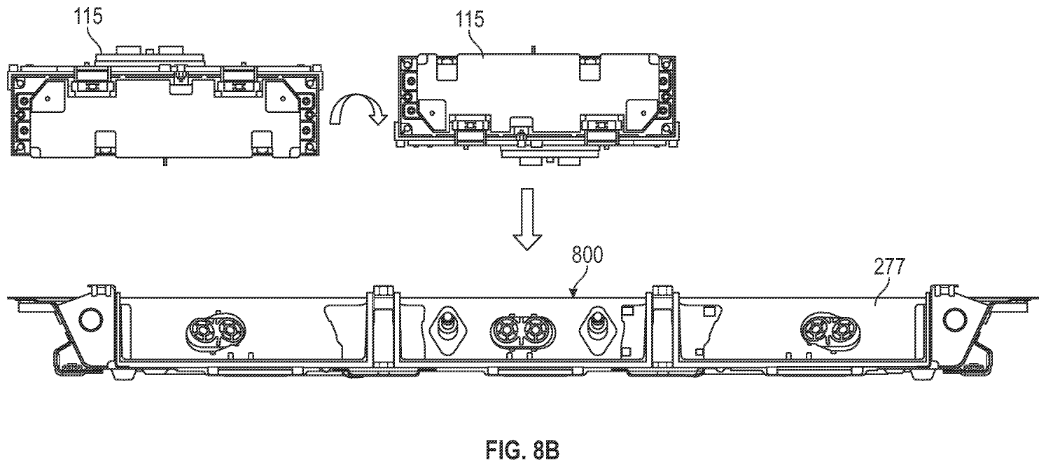

FIG. 8A illustrates a top view of the lid 277 in the inverted position, after one battery module 115 has been lowered into the lid (e.g., between two longitudinal members 312 that run from the front to the rear of the lid 277). As shown, the lid 277 may include spaces 800 (e.g., module bays), within the space 333, for additional battery modules 115 (e.g., two additional battery modules 115) or other battery subassemblies. FIG. 8B illustrates how a battery module 115 (or other battery subassembly or group of battery cells 120) may be assembled in a first orientation, and flipped (e.g., into an inverted configuration for the battery module) for insertion (e.g., lowering) into a space 800 in the inverted lid 277 (e.g., prior to flipping of the lid with the installed battery module 115 after the battery module 115 has been secured to the lid).

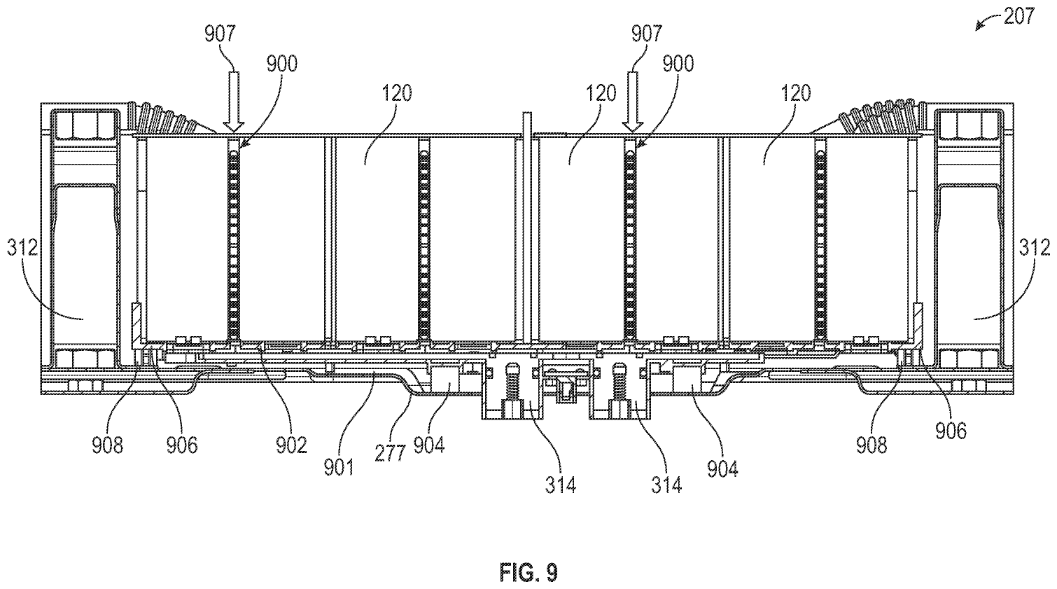

FIG. 9 illustrates a cross-sectional view of an enlarged portion of the battery pack 110 of FIG. 8A. As illustrated by FIG. 9, each of one or more battery subassemblies (e.g., battery modules 115) may include a current collector assembly 902. For example, the current collector assembly 902 may include multiple tabs welded to multiple battery cells 120, in order to collect the current from the battery cells 120 for output from the battery pack 110. As shown in FIG. 9, the current collector assembly (CCA) 902 may include a flange 906 and/or a standoff 908. The standoff 908 may define a spacing between the one or more battery subassemblies and the lid 277. In one or more other implementations, the standoff 908 may be formed separately from the CCA 902 (e.g., on the lid 277, or as a separate component of the battery pack 110). In one or more implementations, the standoff 908 and/or the flange 906 may provide datum features (e.g., a primary datum feature for setting the location(s) of the battery subassembly (ies) (e.g., battery modules 115) within the lid 277. As shown in FIG. 9, a seal 904 may extend around the terminals 314, and may be compressed (e.g., by the weight of the battery subassembly while the lid 277 is in the inverted position), against an internal surface of the lid 277. In this way, the battery pack 110 can be assembled with the lid 277 in a “holding water” (inverted) orientation so that the top of the battery modules 115 touch down on the lid assembly (e.g., an assembly including the lid 277, the longitudinal members 312, the sidewall structures 271, and/or other battery pack features or components).

As illustrated by FIG. 9, once the battery cells 120 (e.g., of a battery subassembly, such as a battery module 115) have been inserted into the inverted lid 277, a potting material (e.g., potting material 309 of FIG. 3) may be provided (e.g., poured, dispensed, or otherwise provided, as indicated by arrows 907) into the interstitial spaces 900 between the battery cells 120 (e.g. between two or more battery cells of each of the one or more battery subassemblies), and into a space 901 (e.g., defined by the standoffs 908) between the one or more battery subassemblies (e.g., the battery cells 120) and the lid 277. Because the potting material is provided into the lid 277 while the lid is in the inverted position of FIG. 9 (e.g., and the potting material is thus pulled downward toward the top of the lid 277 and the CCA 902, and into the space 901, by gravity), the gap 308 (see, e.g., FIG. 3) between the tray 302 and the one or more battery subassemblies may remain free of the potting material (e.g., without providing any particular components to block the flow of the potting material into the gap 308, since the potting material naturally flows downward away from the gap 308). For example, this orientation may allow the potting material 309 to be dispensed into the pack without fouling the cell vents and without a component to protect vent channels from being filled with potting material.

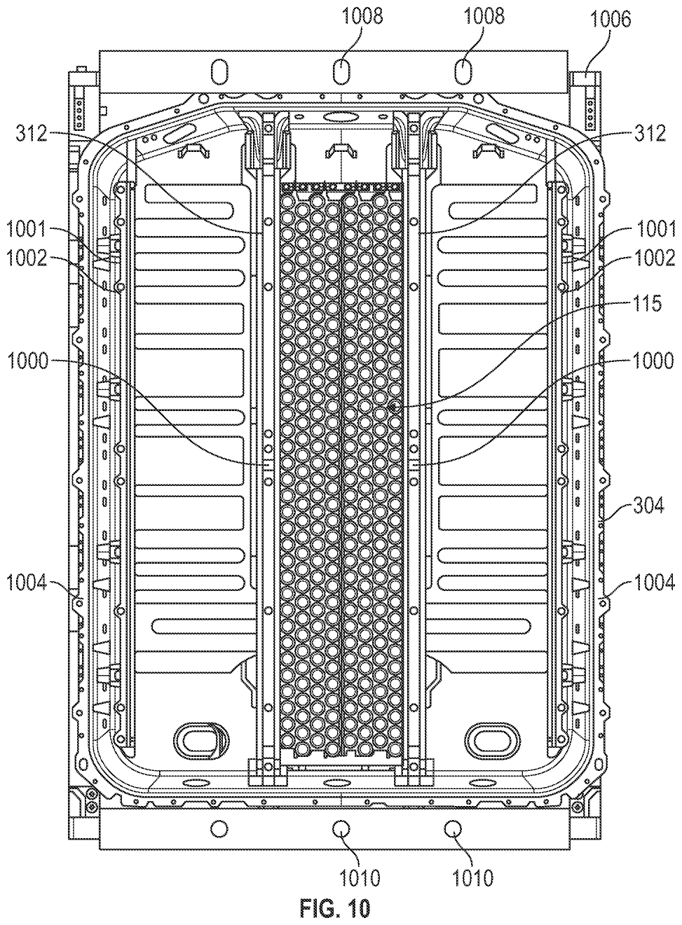

FIG. 10 illustrates various aspects of module X/Y datuming of the battery subassembly to the enclosure formed by the lid 277. For example, a module load lift assist may be designed with selective compliance and centering, such as to limit re-alignment loads passed through CCA datums. As shown in FIG. 10, one or more datums may be provided for aligning the battery modules 115 for insertion into the lid 277. As examples, one or more datums 1000 may be provided on one or more of the longitudinal members 312, one or more datums 1002 may be provided on one or more of the outer longitudinal members 1001, and/or one or more datums 1004 may be provided on the flange 304 of the lid 277. In one or more implementations, datums may also, or alternatively, be provided on a palette fixture 1006 to which the lid 277 may be mounted during assembly of the battery pack 110. For example, the palette fixture 1006 may include one or more two-way datums 1008 at a first end thereof, and one or more four-way datums 1010 at an opposing second end thereof. In one or more implementations, a module load lift assist that lifts the battery module 115 (e.g., and that is aligned to the battery module 115 using the datum 702 and the datum 704 of FIG. 7) may be aligned and/or indexed to the datums 1000, 1002, 1004, 1008, and/or 1010, to align the battery module 115 for insertion into the lid 277 that is in the inverted position.

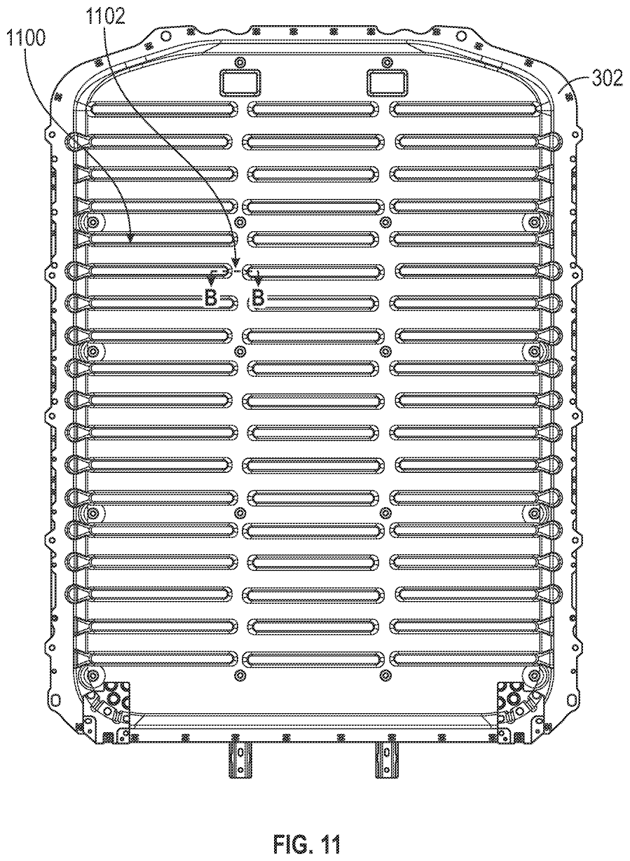

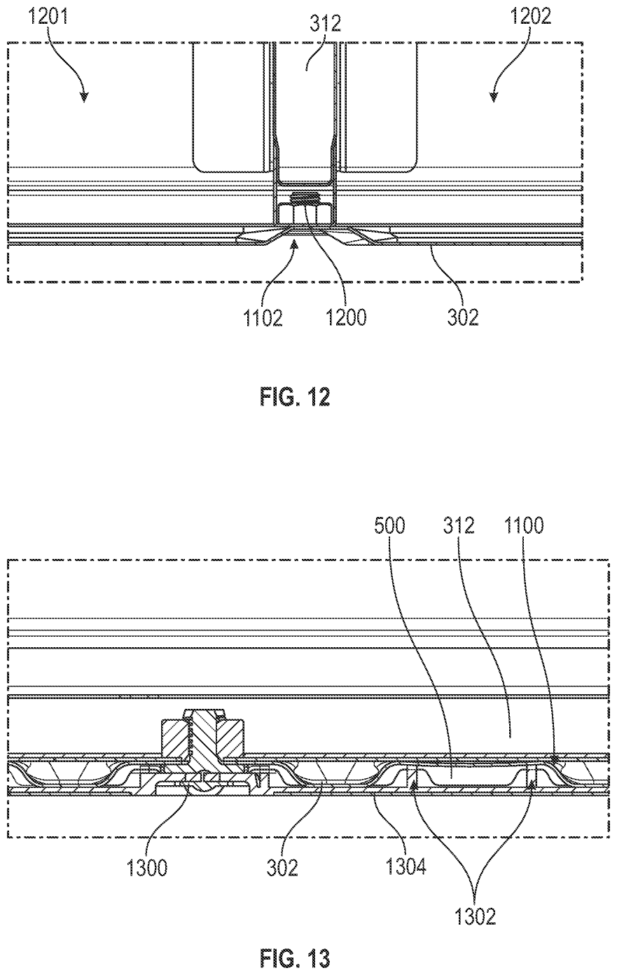

FIG. 11 illustrates a top view of the tray 302 in accordance with one or more implementations. As shown in FIG. 11, the tray 302 may include one or more ribs 1100 (e.g., to form stiff beam elements on the tray panel). The tray 302 may also include a feature 1102 (e.g., a discontinuity) between adjacent pairs of the ribs 1100. FIG. 12 illustrates an enlarged cross-sectional view of a portion of the tray 302, taken along the line B-B of FIG. 11. As shown in FIG. 12, the feature 1102 may be configured to interface with a longitudinal member 312 of the energy volume enclosure 205 (e.g., of the lid 277) to fluidly isolate a first region 1201 (e.g., a space 800 in which a first battery module 115 or other group of battery cells 120 is disposed) within the energy volume enclosure 205 from a second region 1202 (e.g., another space 800 in which a second battery module 115 or other group of battery cells 120 is disposed) within the energy volume enclosure 205. As shown, a bolt 1200 may be configured to secure a metal-to-metal contact between the feature 1102 and the bottom end of the longitudinal member 312. Providing this isolation achieved by interrupting the tray panel ribs 1100 at the longitudinal beams such that there is a metal-to-metal interface, the battery pack 110 may be configured to block the flow of air and/or debris from one module bay to another, including in the event of a thermal runaway caused by a cell or module failure.

As described herein, in one or more implementations, the battery pack 110 may also include a skid plate 500 attached to an outer surface of the tray 302. In one or more implementations, the skid plate 500 may include one or more features that interface with the ribs 1100 of the tray 302. For example, as illustrated in FIG. 13 (e.g., a cross-sectional view with the cross section taken along a longitudinal member 312), the tray 302 may be attached to the longitudinal member 312 of the energy volume enclosure 205 by one or more fasteners 1300, and the skid plate 500 may include one or more ribs 1302 positioned within a space defined by one of the ribs 1100 of the tray 302. For example, the one or more fasteners 1300 may include one or more t-nuts and corresponding bolts, and/or other types of nuts, bolts, screws, welds or other fasteners. Use of t-nuts as the fasteners 1300 may provide additional load distribution and/or stability for the connection between the tray 302 and the longitudinal member 312. For example, the skid plate 500 may include cross car ribs 1302 inside tray panel ribs 1100 (e.g., extending into a space or recess formed by an undulation in the tray 302, the undulation corresponding to one of the ribs 1100). In one or more implementations, the ribs 1100 of the tray 302 may alternatively be implemented as crowned ribs (e.g., that protrude into corresponding recesses in the longitudinal member) to increase stiffness of ribs 1100. In one or more implementations, the battery pack 110 may include an additional layer 1304 (e.g., a layer of aluminum, carbon fiber, glass fiber, or other sheet of material) between the tray 302 and the skid plate 500. In one or more implementations, attaching the battery subassemblies and/or cells to the lid 277 (e.g., rather than the tray 302) may be allow the ribs 1100 extend further outward toward the edges of the tray 302 and toward the location of a vehicle rocker of a vehicle in which the battery pack 110 is installed.

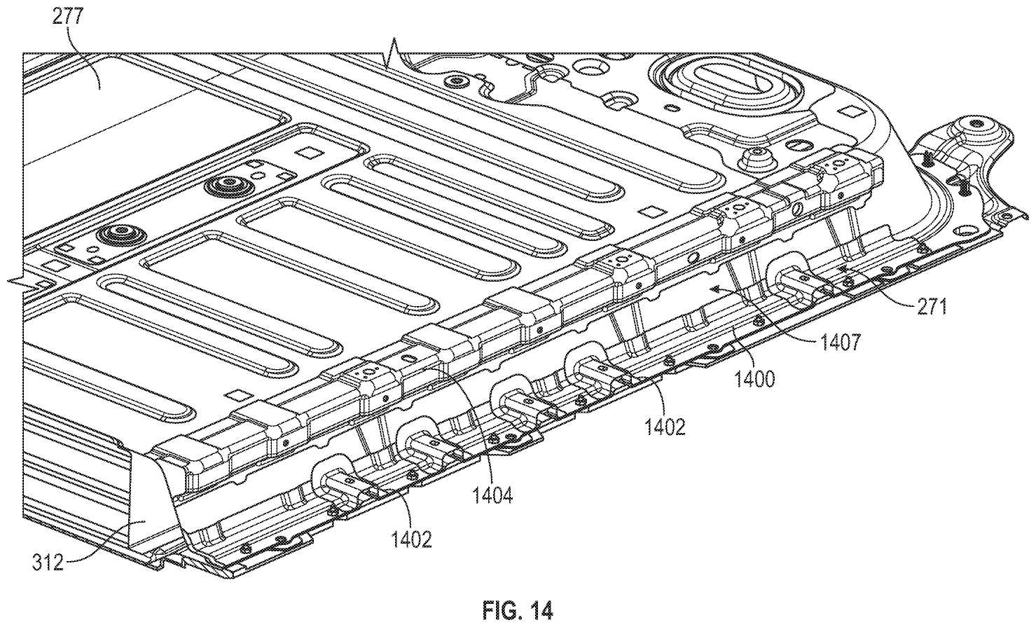

FIG. 14 illustrates a side perspective view of a portion of the battery pack 110, in which the sidewall structures 271 can be seen. As shown, the sidewall structures 271 may include various impact absorption features mounted along a sidewall 1407 (e.g., one of the sidewalls 259 of the lid 277) of the energy volume enclosure 205. As described herein (see, e.g., FIG. 2A), the energy volume enclosure 205 for the battery pack 110 may include a front end 267 and a rear end 269. As shown in FIG. 14, a sidewall 1407 that extends along a direction between the front end 267 and the rear end 269 may include impact absorption features. As shown, the battery pack 110 may include a first set impact absorption features (e.g., sidewall structures 271) on an external surface of the sidewall 1407. As shown, the first set of impact absorption features may include at least one beam (e.g., beam 1400 or beam 1404) attached to an outer surface of the lid 277 and extending in a direction that runs between the front end 267 and the rear end 269. For example, the at least one beam may include: a first beam 1404 attached (e.g., welded) to the outer surface of the lid 277 at a top of the sidewall 1407, and a second beam 1400 attached (e.g., welded) to a flange 304 at a bottom of the lid 277. As shown, the first set of impact absorption features may also include one or more reinforcement members 1402 attached to, and spaced apart along, the second beam 1400. The sidewall structures 271 of FIG. 14 may provide an outer longitudinal section of the battery pack 110 for beam stiffness in GB crush and energy absorption in side pole impact tests.

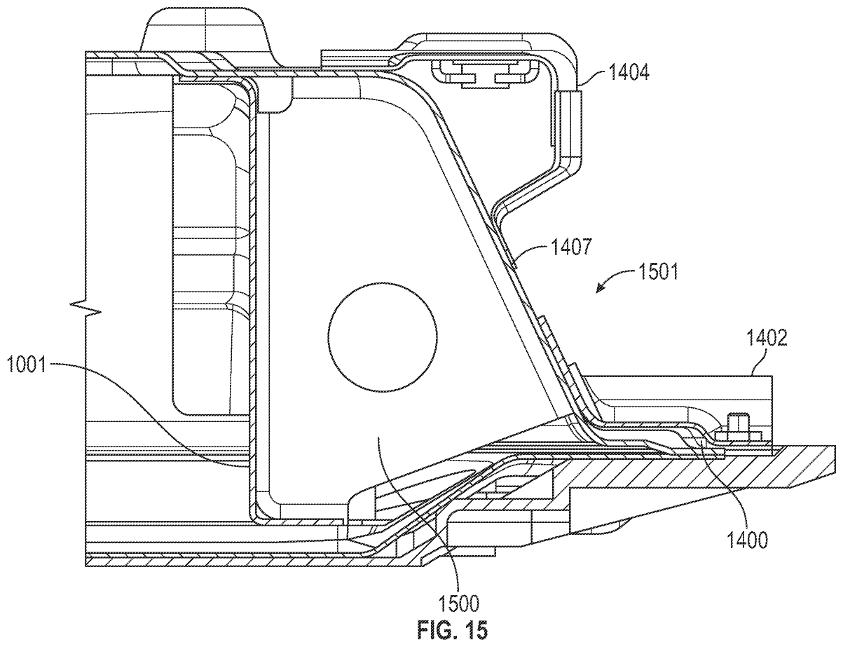

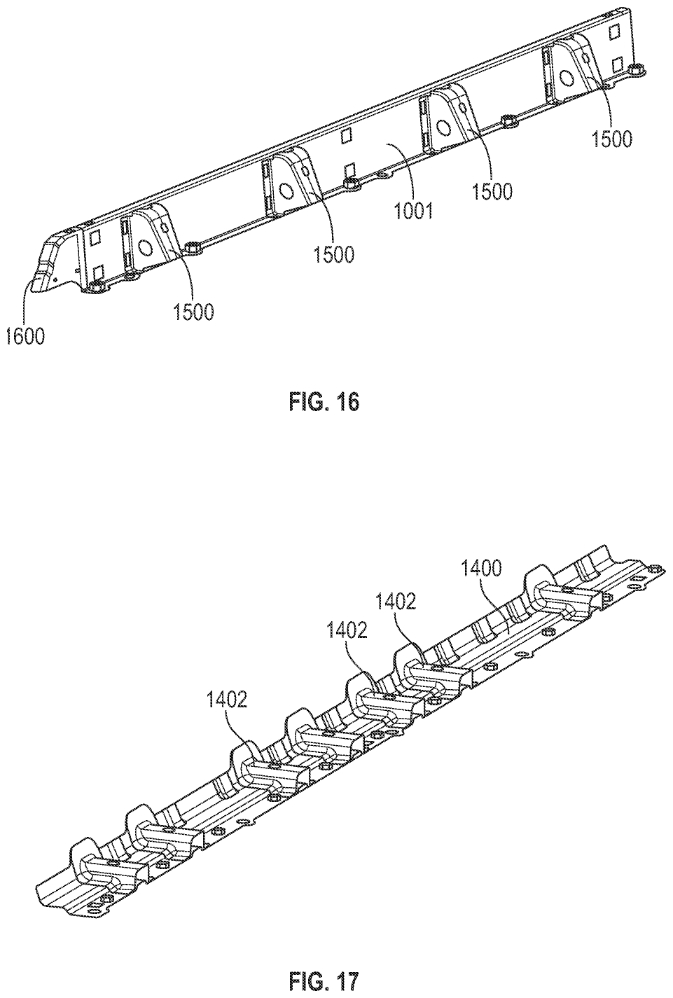

FIG. 15 illustrates a cross-sectional view of a portion of the battery pack 110, in which additional details of the sidewall structures 271 can be seen. As shown, a space 1501 may be provided between the beam 1404 and the reinforcement members 1402 (e.g., for mounting of cables, such as electrical, hydraulic, and/or thermal cables, that run between the front and the rear of a vehicle). As shown, in addition to the first set of impact absorption features (e.g., the beam 1400, the beam 1404, and the reinforcement members 1402) on the external surface of the sidewall 1407, the battery pack 110 may also include a second sent of impact absorption features on, and/or interior to, an internal surface of the sidewall 1407. For example, the second set of impact absorption features may include a set of bulkheads 1500 that are attached to an outer longitudinal member 1001 and positioned interior to the lid 277. For example, FIG. 16 illustrates a perspective view of the outer longitudinal member 1001 with multiple bulkheads 1500 attached (e.g., welded) thereto. As shown, the bulkheads 1500 may be spaced apart along a length of the outer longitudinal member 1001. As shown, an additional bulkhead 1600 may be attached (e.g., welded) to the outer longitudinal member 1001 at an end of the outer longitudinal member 1001. FIG. 17 illustrates a perspective view of the beam 1400 with multiple reinforcement members 1402 attached (e.g., welded) thereto.

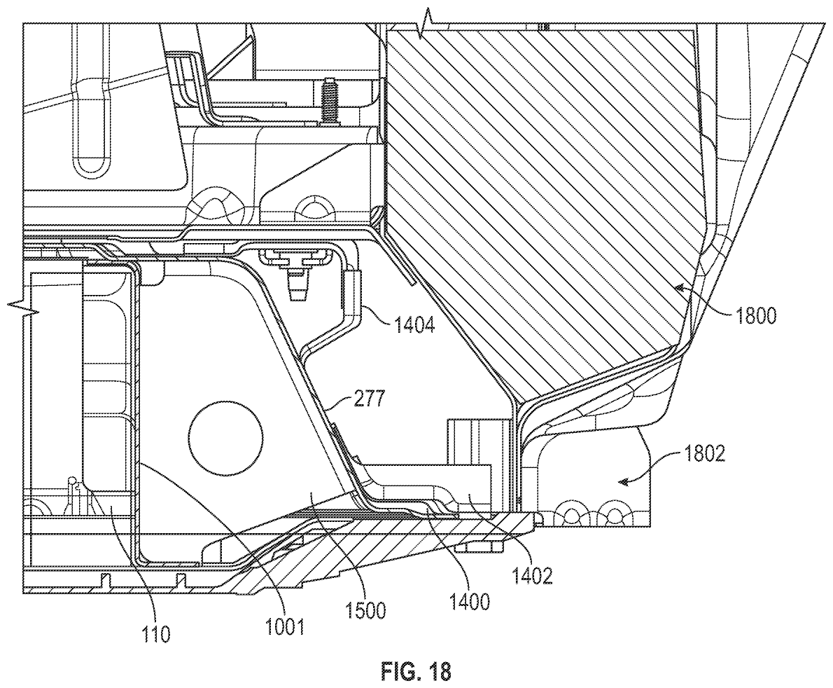

FIG. 18 illustrates additional details of the battery pack 110 of FIG. 15 implemented in a vehicle 100. As shown in FIG. 18, the battery pack 110, including the bulkheads 1500 attached to the outer longitudinal member 1001 and interior to the lid 277, the beams 1400 and 1404 welded to the outer surface of the lid 277, and the reinforcement members 1402 attached (e.g., welded) to the beam 1400, may be positioned interior to one or more vehicle body structures, such as a body rocker assembly 1800 and/or a body structure 1802, of a vehicle (e.g., vehicle 100). In the event of an impact to the vehicle 100 (e.g., to side of the vehicle 100), the body rocker assembly 1800 and/or the body structure 1802 may transfer some or all of a force of the impact to the beam 1404, the beam 1400, and/or the reinforcement members 1402. The beam 1404, the beam 1400, and/or the reinforcement members 1402 may distribute some or all of the force along the beams 1400 and/or 1404, and/or may deform to absorb some or all of the force. In one or more use cases, some of the force may be transferred to the lid 277, the bulkheads 1500, and/or the outer longitudinal member 1001. The lid 277, the bulkheads 1500, and/or the outer longitudinal member 1001 may distribute some or all of the force along the beams outer longitudinal member 1001 and/or 1404, and/or may deform to absorb some or all of the force. Although the features of FIGS. 14-18 a described in connection with one sidewall 259 of the lid 277, it is appreciated that the sidewall structures of 271 and bulkheads 277 may be repeated on an opposing sidewall 259 of the lid 277.

As illustrated by FIGS. 15-18, the battery pack 110 may be provided with sidewall features, including the outer longitudinal member 1001 (e.g., attached to the battery modules 115), the beam 1400, the beam 1404, the reinforcement members 1402, and/or the bulkheads 1500, that include stiff beam members that allow a crush of outer portions of the pack to happen without loading modules and/or cells. Using the side structures described herein, the battery pack 110 may act as a load path for side impacts to the vehicle, without transferring the impact force to the battery cells. The long side members disclosed herein (e.g., the outer longitudinal members 1001, the beam(s) 1404, and/or the beam(s) 1400) may provide torsional and bending stiffness to the battery pack 1110 and improve modal performance of the battery pack 110 and/or the vehicle 100. In various implementations, any commodity, such as stampings, plastic inserts, and/or or extrusions can be used inside of the battery pack 110 pack as bulkheads 1500 for energy absorption and/or stiffness. In various implementations, any materials, such as steel, aluminum, or reinforced plastic can be used with the same structure concept. The side structure design described herein can be scaled up or down based on an expected magnitude of a load and based on vehicle mass.

In one or more implementations, the battery pack 110 may form a structural component of the vehicle 100. For example, the vehicle 100 may be provided without a structural frame that runs from the front to the rear of the vehicle. For example, the vehicle body and front and/or rear subframes may be mounted to the battery pack 110. Providing the sidewall structures 271 as described herein may allow the battery pack 110 to perform side-impact protection functions previously performed by a vehicle frame, while reducing the weight and materials of the vehicle (e.g., by removing the frame), thereby meeting vehicle safety standards while increasing the range of the vehicle.

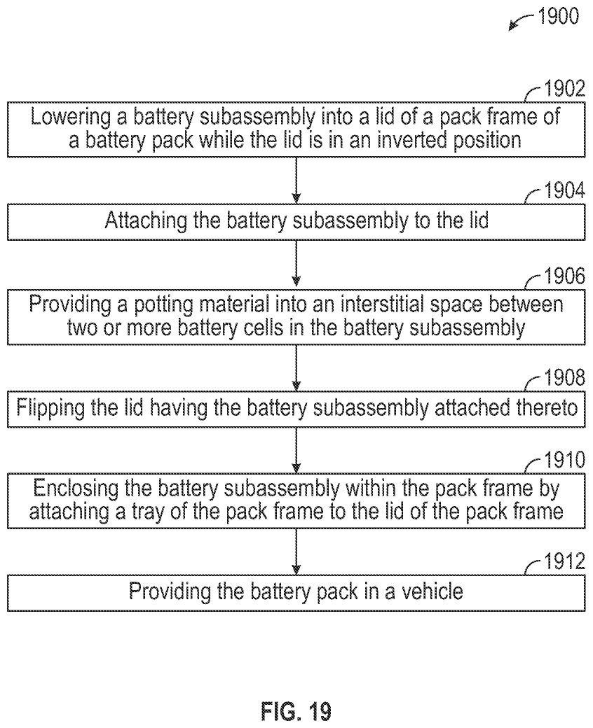

FIG. 19 illustrates a flow diagram of an example process 1900 that may be performed for assembling a battery pack, in accordance with implementations of the subject technology. For explanatory purposes, the process 1900 is primarily described herein with reference to the battery pack 110 of FIGS. 1A-18. However, the process 1900 is not limited to the battery pack 110, and one or more blocks (or operations) of the process 1900 may be performed by or with one or more other structural components of other devices, systems, or battery assemblies or subassemblies. Further for explanatory purposes, some of the blocks of the process 1900 are described herein as occurring in serial, or linearly. However, multiple blocks of the process 1900 may occur in parallel. In addition, the blocks of the process 1900 need not be performed in the order shown and/or one or more blocks of the process 1900 need not be performed and/or can be replaced by other operations.

As illustrated in FIG. 19, at block 1902, a battery subassembly (e.g., a battery module 115, such as a battery module 115B, 115D, or 115F) may be lowered (e.g., as indicated by arrows 400 of FIG. 4) into a lid (e.g., lid 277) of an enclosure (e.g., energy volume enclosure 205) of a battery pack (e.g., battery pack 110) while the lid is in an inverted position (e.g., as illustrated in FIGS. 4 and 8B). In the inverted position of the lid, an opening 431 spanning a bottom of the lid may face upward to allow objects to be lowered into the lid.

At block 1904, the battery subassembly may be attached to the lid. Attaching the battery subassembly to the lid may include attaching a carrier for one or more battery cells (e.g., battery cells 120) to the lid and/or attaching the battery cells 120 to the lid.

At block 1906, a potting material may be provided into an interstitial space (e.g., interstitial space 900) between two or more battery cells (e.g., battery cells 120) in the battery subassembly. In one or more implementations, attaching the battery subassembly to the lid at block 1904 may include attaching the battery subassembly to the lid using the potting material (e.g., by allowing the potting material to flow into and cure in the space(s) between the battery subassembly and the lid, and thereby attach the battery subassembly to the lid). In one or more other implementations, attaching the battery subassembly to the lid may include attaching the battery subassembly to the lid using one or more fasteners (e.g., bolts, screws, clips, etc.), using one or more welds, using an adhesive, or any other suitable attachment mechanism. For example, in one or more implementations, attaching the battery subassembly to the lid may include providing a potting material into the lid containing the battery subassembly, and allowing the potting material to cure in one or more interstitial spaces between battery cells of the battery subassembly, and between the lid and a carrier (e.g., carrier 700) and/or a CCA (e.g., CCA 902). Attaching the battery subassembly to the lid may also include allowing the potting material to flow downward, due to gravity, toward the lid 277 and into the interstitial spaces between battery cells of the battery subassembly, and between the lid and the carrier (e.g., carrier 700) and/or the CCA (e.g., CCA 902).

At block 1908, the lid having the battery subassembly attached thereto may be flipped (e.g., as illustrated in FIG. 4). Flipping the lid may be performed before or after a tray (e.g., tray 302) and/or one or more other layers (e.g., a skid plate 500 and/or a layer 1304) have been attached to the lid, to cover the opening in the bottom of the lid that is upward facing when the lid is in the inverted position.

For example, at block 1910, the battery subassembly may be enclosed within the energy volume enclosure (e.g., within the space 333) by attaching a tray (e.g., tray 302) of the energy volume enclosure to the lid of the energy volume enclosure. For example, the tray may be attached to the lid of the energy volume enclosure using one or more bolts or other fasteners. In one or more implementations, the tray 302 and/or a skid plate 500 may be attached to the lid to close the energy volume enclosure prior to flipping the lid having the battery subassembly attached thereto.

In one or more implementations, the process 1900 may also include mechanically coupling a modular electrical component assembly (e.g., modular electrical component assembly 290) to the lid, and electrically coupling the battery subassembly to the modular electrical component assembly via the lid (e.g., using one or more connectors that pass through one or more respective openings in the top of the lid). Mechanically and electrically coupling the modular electrical component assembly to the energy volume enclosure may include bolting an enclosure of the modular electrical component assembly to the lid of the energy volume enclosure, and electrically coupling one or more high voltage terminals (e.g., terminals 314) on the energy volume enclosure to electrical circuitry within the modular electrical component assembly. In one or more implementations, the process 1900 may also include (e.g., at block 1912) providing the battery pack in a vehicle (e.g., vehicle 100).

In one or more implementations, lowering the battery subassembly into the lid may include lowering the battery subassembly into the lid may include while the battery subassembly is in an inverted configuration for the battery subassembly. In one or more implementations, lowering the battery subassembly into the lid may include loading the battery subassembly into the lid dry (e.g., with no potting in the battery subassembly). The potting can then be provided, at block 1906, at a pack level, and to fill in the inter-cell spaces and the connection to the lid 277 at the same time. For example, providing the potting material at block 1906 may include dispensing a potting material that cures as an adhesive through the cells 120. As the potting material flows in, it may fill into the bottom of the inverted lid 277 and cure to hold the battery subassembly in place. In this way, the potting material can form an adhesive the bears loads including for shock and vibe crash durability, or the like. By providing a robust attachment between the battery cells 120 and the lid 277 of the battery pack 110 in this way, the mechanical performance of the cells may contribute to the stiffness of the battery pack 110 and/or a vehicle 100 in which the battery pack is installed. For example, the moment of inertia of the entire top of the energy volume enclosure 205 can be increased by attaching the battery cells 120 and/or other battery subassembly structures at the top of the battery pack 110 (e.g., attached to the lid 277 as described herein).

Attaching the battery subassemblies to the lid 277 as described herein may help to reduce the tolerances and/or the number of materials in the Z-stack of the battery pack 110. For example, the location of the terminals 314 and/or associated busbars extending through the lid 277 from the battery subassemblies, relative to the mounting location of interfacing terminals of the modular electrical component assembly 290 on the top of the lid 277, may be controlled more precisely by lowering the battery modules 115 into the inverted lid 277 as shown and described herein (e.g., in contrast with mounting the battery subassemblies to a bottom of the energy volume enclosure and then installing the lid above the battery subassemblies). Attaching the battery subassemblies to the lid 277 as described herein may also help to optimize the amount of potting material 309 (e.g., a foaming or other curing potting material) used in a battery pack 110, such as by optimizing the thickness of the spaces to be filled with that potting material and using gravity to move the potting material to, rather than away from, desired potting locations at the tops of the cells and/or the CCA. Thus, attaching the battery subassemblies to the lid 277 as described herein may reduce the number of components for sealing and limiting flow of potting material into places (e.g., gap 308) where the presence of potting material is undesirable. Accordingly, attaching the battery subassemblies to the lid 277 as described herein may provide additional benefits in terms of reduced cost, weight, and/or manufacturing complexity, while providing improvements in structural performance.

Aspects of the subject technology can help improve the reliability and/or range of electric vehicles. This can help facilitate the functioning of and/or proliferation of electric vehicles, which can positively impact the climate by reducing greenhouse gas emissions.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), unless the element is expressly recited using the phrase “means for” or, in the case of a method claim, the element is recited using the phrase “step for”.

Those of skill in the art would appreciate that the various illustrative blocks, modules, elements, components, methods, and algorithms described herein may be implemented as hardware, electronic hardware, computer software, or combinations thereof. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. An apparatus, comprising:
a battery pack, comprising:
a lid that forms a top and a plurality of sidewalls of an energy volume enclosure of the battery pack;
one or more battery subassemblies enclosed within a space defined by the top and the plurality of sidewalls of the lid; and
a tray attached to the lid to enclose the one or more battery subassemblies within the space defined by the top and the plurality of sidewalls of the lid.

2. The apparatus of claim 1, wherein the tray forms a bottom wall of the energy volume enclosure and is configured to attach to the lid using a plurality of fasteners disposed around a periphery of the energy volume enclosure to enclose the one or more battery subassemblies within the space defined by the top and the plurality of sidewalls of the lid, and wherein the battery pack further comprises an air gap between the tray and the one or more battery subassemblies.

3. The apparatus of claim 2, wherein the one or more battery subassemblies each comprise one or more battery cells, and wherein each of the one or more battery cells have a vent disposed adjacent the air gap.

4. The apparatus of claim 2, wherein each of the one or more battery subassemblies is attached to the lid, and wherein each of the one or more battery subassemblies comprises a current collector assembly having a standoff that defines a spacing between the one or more battery subassemblies and the lid.

5. The apparatus of claim 4, wherein the battery pack further comprises a potting material in an interstitial space between two or more battery cells of each of the one or more battery subassemblies, and in a space between the one or more battery subassemblies and the lid.

6. The apparatus of claim 5, wherein the air gap between the tray and the one or more battery subassemblies is free of the potting material, and wherein the potting material attaches the one or more battery subassemblies to the lid.

7. The apparatus of claim 2, wherein the tray comprises:
a plurality of ribs; and
a feature between adjacent pairs of the plurality of ribs, the feature configured to interface with a longitudinal member of the energy volume enclosure to fluidly isolate a first region within the energy volume enclosure from a second region within the energy volume enclosure.

8. The apparatus of claim 7, wherein the battery pack further comprises a skid plate attached to an outer surface of the tray.

9. The apparatus of claim 8, wherein the tray is attached to the longitudinal member of the energy volume enclosure by one or more fasteners, and wherein the skid plate comprises one or more ribs positioned within a space defined by one of the ribs of the tray.

10. The apparatus of claim 1, further comprising a plurality of impact absorption features mounted along one of the plurality of sidewalls of the lid.

11. The apparatus of claim 1, wherein the apparatus comprises a vehicle, and wherein the battery pack is implemented in the vehicle.

12. An enclosure for a battery pack, the enclosure comprising:
a front end;
a rear end;
a sidewall extending between the front end and the rear end;
a first plurality of impact absorption features on an external surface of the sidewall; and
a second plurality of impact absorption features on an internal surface of the sidewall.

13. The enclosure of claim 12, further comprising:
a lid; and
an outer longitudinal member extending from the front end to the rear end,
wherein the second plurality of impact absorption features comprise a plurality of bulkheads that are attached to the outer longitudinal member and positioned interior to the lid.

14. The enclosure of claim 13, wherein the first plurality of impact absorption features include at least one beam attached to an outer surface of the lid, the at least one beam extending in a direction that runs between the front end and the rear end.

15. The enclosure of claim 14, wherein the at least one beam comprises:
a first beam attached to the outer surface of the lid at a top of the sidewall; and
a second beam attached to a flange at a bottom of the lid.

16. The enclosure of claim 15, wherein the first plurality of impact absorption features comprise a plurality of reinforcement members attached to, and spaced apart along, the second beam.

17. A method, comprising:
lowering a battery subassembly into a lid of an energy volume enclosure of a battery pack while the lid is in an inverted position;
attaching the battery subassembly to the lid;
providing a potting material into an interstitial space between two or more battery cells in the battery subassembly;
flipping the lid having the battery subassembly attached thereto; and
enclosing the battery subassembly within the energy volume enclosure by attaching a tray of the energy volume enclosure to the lid of the energy volume enclosure.

18. The method of claim 17, wherein lowering the battery subassembly into the lid comprises lowering the battery subassembly into the lid while the battery subassembly is in an inverted configuration of the battery subassembly, the method further comprising providing the battery pack in a vehicle.

19. The method of claim 17, wherein attaching the battery subassembly to the lid comprises attaching the battery subassembly to the lid with the potting material.

20. The method of claim 19, further comprising mechanically coupling a modular electrical component assembly to the lid and electrically coupling the modular electrical component assembly to the battery subassembly via the lid.
